(19) United States
(12) Patent Application Publication
(10) Pub. No.: US 2007/0118735 A1
(43) Pub. Date: May 24, 2007

(54) Systems and methods for trusted information exchange

(76) Inventors: Jeff Cherrington, Cedarburg, WI (US); Joe Sturonas, Lake Bluff, IL (US)

Correspondence Address: MCANDREWS HELD & MALLOY, LTD, 500 WEST MADISON STREET, SUITE 3400, CHICAGO, IL, 60661, US

(21) Appl. No.: 11/595,689

(22) Filed: Nov. 10, 2006

Related U.S. Application Data
(60) Provisional application No. 60/736,047, filed on Nov. 10, 2005.

(51) Int. Cl. H04L 9/00

(52) U.S. Cl. 713/155

(57) ABSTRACT

Systems and methods are provided which allow for the secure exchange of information between a sender and a receiver. The systems and methods utilize a mutually trusted credential creator to authenticate the identities of at least the sender and optionally the receiver. The systems and methods also provide for the use of host applications capable of encrypting and digitally signing a secure file format. The secure file format is preferably only alterable with the consent of the sender.

### CROSS REFERENCE TO RELATED APPLICATIONS

This application claims the benefit of U.S. Provisional Application No. 60/736,047 filed Nov. 10, 2005 entitled “SYSTEMS AND METHODS FOR TRUSTED INFORMATION EXCHANGE,” which is hereby incorporated by reference in its entirety.

### BACKGROUND OF THE INVENTION

The present invention generally relates to systems and methods for trusted information exchange. More particularly, the present invention relates to systems and methods for securely transferring computer files between a trusted source and a trusted receiver.

Computer files have been transferred between users for many years. Typically, computer files are exchanged using well-known, pre-defined file transfer software programs such as the File Transfer Protocol (FTP) or e-mail. FTP operates to establish a communication protocol to allow communication between a sender's computer and a receiver's computer. After the connection between the two computers has been established, files may be transferred from the sender's computer to the receiver's computer using FTP.

Another methodology that provides the ability to transfer a file from a first user's computer to a second user's computer is e-mail. A typical e-mail program allows a sender to select one or more receivers by using a receiver's e-mail address and then allows a sender to select one or more files to be transmitted to the one or more receivers.

Additionally, files may be transferred from a sender to a receiver over the internet by using an internet protocol such as Hyper Text Transfer Protocol (HTTP). That is, HTTP is a standard communication method that allows computers to exchange information and data files using the internet. Additional security may be provided to the exchange of files by using HTTPS, a secure form of HTTP. That is, HTTPS may provide an additional level of security to information and files as they move between computers.

As with any communication methodology, the security of FTP, e-mail and HTTP is of particular concern. Users of the communication methodologies want to have confidence that their communications will be received only by the designated receivers (non-intercept) or if other parties receive the communications, then the other parties will not be able to view the communications (reception security).

However, the FTP communication protocol does not include a methodology for verifying the identity of the sender or the receiver. Further, the FTP communication protocol does not include a methodology for preventing other parties from viewing communications between the sender and receiver.

With regard to e-mail, e-mail applications are available today that include security features such as data encryption and digital signing. However, the use of these security features is not required by the application and is instead optionally selected by the user of the e-mail application. Consequently, not all communications are encrypted and/or signed. Additionally, even if an e-mail communication is encrypted and signed, once the e-mail communication is received by the receiver, the receiver typically verifies the signature and decrypts the e-mail, and then stores the decrypted version of the e-mail. Similarly, any files that might have been attached to the e-mail are typically decrypted and stored.

Consequently, the security provided by the e-mail application is available to files only while the file resides in the sender's or receiver's email data storage facility. Once the files are opened to be available for use outside of the e-mail program, the security provided by the email program is lost.

Similarly, HTTPS is available for use for internet communications, but most internet communications take place without the use of HTTPS. Additionally, even if HTTPS is used, once the communication is received and decoded at the receiver's computer, the uncoded version is then stored on the receiver's computer. Consequently, the security provided by HTTPS is not maintained once the file or communication is stored on the receiver's computer.

Similarly, other software programs and protocols are available today that provide some security in the exchange of computer files, however, the protection provided by these programs is limited because the programs only protect the data while the data is in transit. That is, the programs do not protect the computer files before or after the computer files are transferred. Another limitation of these software programs is that they only provide protection between a specifically designated sender and a specifically designated receiver. If the receiver receives a file from the sender and then decides to transfer the file to a second receiver, then the protection methodology employed during the communication between the sender and the first receiver does not automatically apply to the communication between the first receiver and the second receiver.

Further, although several methods of authenticating a sender of computer files are known today, these methods suffer from several limitations. More specifically, although a file may be signed with the digital certificate of a specific user, these methods are limited because the methods do not compare the digital certificate included in a file with a confirmed digital certificate associated with a specific sender. Consequently, although the present methodologies may verify that a file was signed using a specific digital signature, the present methodologies are unable to verify that the file originated with a specific user. Another limitation of a digital certificate in the form of an X.509 digital certificate is that it identifies only a single entity.

Consequently, a communication protocol that provides for trusted exchange between users may be highly desirable. Trusted exchange refers to a communication protocol that preferably allows communications and transmitted files to be verified as to origin of communication, and also preferably allows communications to be secure and free from interception. Additionally, a trusted exchange protocol that allows security to persist between multiple transmission may also be highly desirable.

Thus, a need has long existed for improved systems and methods for the trusted exchange of computer files to overcome the problems and shortcomings of the current state of the art. A need is especially felt for a system that provides a secure file format that persists between multiple transmissions of the file between different users.

### SUMMARY OF THE INVENTION

One or more of the embodiments of the present invention provide a file format limiting access to a file to the sender and an authorized receiver. Additionally, a mutually trusted credential creator is preferably used to authenticate the identities of the sender and the receiver. Further, the encrypted file format taught prevents access and alteration of a file without the consent of the sender. The sender can choose who may receive a file and what actions the receiver may perform on the file. Additionally, one or more of the embodiments teach the use of host applications to facilitate communication with the file format. The file format is not dependent on a particular computer platform or transmission method

These and other features of the present invention are discussed or apparent in the following detailed description.

### BRIEF DESCRIPTION OF THE DRAWINGS

FIG. 1 illustrates a system of secure information exchange according to an embodiment of the present invention.

FIG. 2 illustrates a system of secure information exchange according to another embodiment of the present invention.

FIG. 3 illustrates a system of secure information exchange according to another embodiment of the present invention.

FIG. 4 illustrates a system for the transmission of a secure file according to an embodiment of the present invention.

FIG. 5 illustrates a system for the transmission of a secure file according to an embodiment of the present invention.

FIG. 6 illustrates a transfer of public keys from a sender to a trusted credential creator according to an embodiment of the present invention.

FIG. 7 illustrates a transfer of a trusted sender credentials from a trusted credential creator to a sender according to an embodiment of the present invention.

FIG. 8 illustrates a transfer of a trusted sender credential and a receiver host application according to an embodiment of the present invention.

FIG. 9 illustrates a system of secure information transmission according to an embodiment of the present invention.

FIG. 10 illustrates a system of secure information transmission according to an embodiment of the present invention.

FIG. 11 illustrates a transfer of a trusted receiver credential from a sender to a receiver according to an embodiment of the present invention.

FIG. 12 illustrates a trusted sender credential according to an embodiment of the present invention.

FIG. 13 illustrates a secure file according to an embodiment of the present invention.

FIG. 14 illustrates a method of establishing a trusted sender credential according to an embodiment of the present invention.

FIG. 15 illustrates a method of creating a secure file according to an embodiment of the present invention.

FIG. 16 illustrates a method of receiving a secure file according to an embodiment of the present invention.

### DETAILED DESCRIPTION OF THE PREFERRED EMBODIMENTS

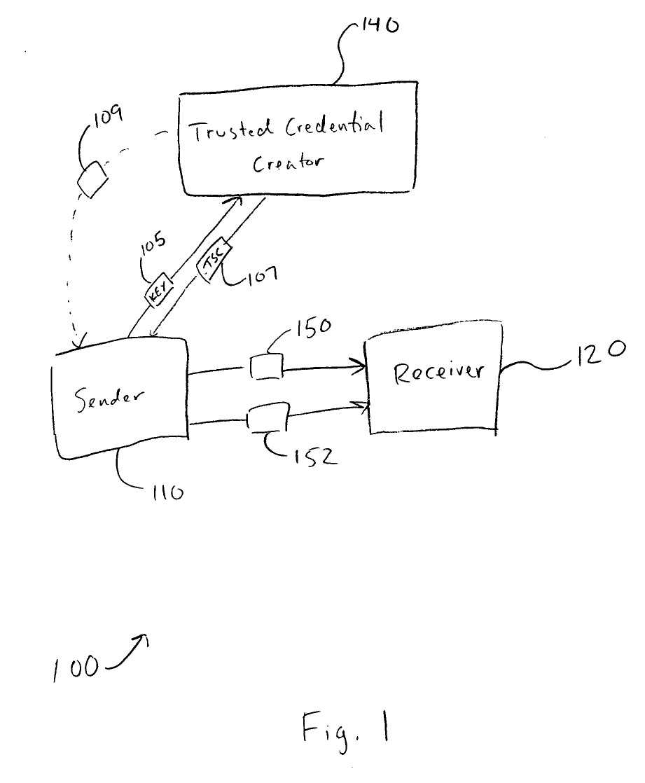

FIG. 1 illustrates a system of secure information exchange 100 according to an embodiment of the present invention. The system 100 includes keys 105, a trusted sender credential 107, independent verification 109, a sender 110, a receiver 120, a trusted credential creator 140, a secure file 150, and a trusted sender credential 152.

The sender 110 may originate a file that is to be protected. For example, a file may be originated at the sender 110 by using a word processing program at the sender 110, or other file origination program. Alternatively, a file may be passed to the sender 110 for secure transmission to the receiver 120, as further described below. The receiver 120 may receive and access a protected file originating from sender 110.

Trusted credential creator 140 may provide sender 110 with a trusted sender credential 107. The trusted sender credential 107 may protect a file originating from the sender 110 and sent to the receiver 120. As shown below, the trusted sender credential 107 may confirm the identity of the sender 110. The trusted sender credential 107 may also confirm that a file originating from the sender 110 has not been accessed by anyone other than the sender 110.

As shown in FIG. 1, the sender 110 is in communication with the receiver 120. The sender 110 is also in communication with the trusted credential creator 140.

In operation, sender 110 may transmit a file or other data from sender 110 to receiver 120. In a first, simplified example, the sender 110 may request a trusted sender credential 107 from the trusted credential creator 140. In response, the trusted credential creator 140 may request keys 105 from the sender 110. The keys 105 may include encryption or digital signing keys. In the first simplified example, the sender 110 provides the keys 105 to the trusted credential creator 140 for inclusion in the trusted sender credential 107.

After receiving the keys 105, the trusted credential creator 140 may send independent verification 109 to the sender 110. As shown further below, the independent verification 109 is sent to the sender 110 to confirm that the sender 110 is the source of the keys 105. In one example, the independent verification 109 may be a telephone call from the trusted credential creator 140 to the sender 110 to confirm the sender's identity. If the sender 110 confirms the independent verification 109, the trusted credential creator 140 may create the trusted sender credential 107 as further shown below. After creating the trusted sender credential 107, the trusted credential creator 140 may send the trusted sender credential 107 to the sender 110.

Continuing with the first, simplified example, at the sender 110, a file or other data is identified that is to be transmitted from the sender 110 to the receiver 120. The file or other data is used by a sender host application to generate a secure file 150. The secure file 150 includes data derived from the original file and also includes a digital certificate and/or metadata.

The sender 110 may send the secure file 150 and the trusted sender credential 152 to receiver 120. The receiver 220 may receive the secure file 150 and the trusted sender credential originating from the sender 110. Additionally, a receiver host application may use the trusted sender credential 152 to verify the contents and origin of the secure file 150 as further described below.

In an alternative embodiment, the secure file 150 and the trusted sender credential 152 are aggregated into a single communication and are then transmitted to the first receiver 120. In another alternate embodiment, the trusted credential creator 140 provides the trusted sender credential 107 to the receiver 120. In yet another alternate embodiment, the sender 110 may be an entity comprising individual senders within the sender entity. Additionally, the receiver 120 may be an entity comprising individual receivers within the receiver entity. In another alternate embodiment, the sender 110 must be established as a trusted source before initiating the exchange of secure file 150.

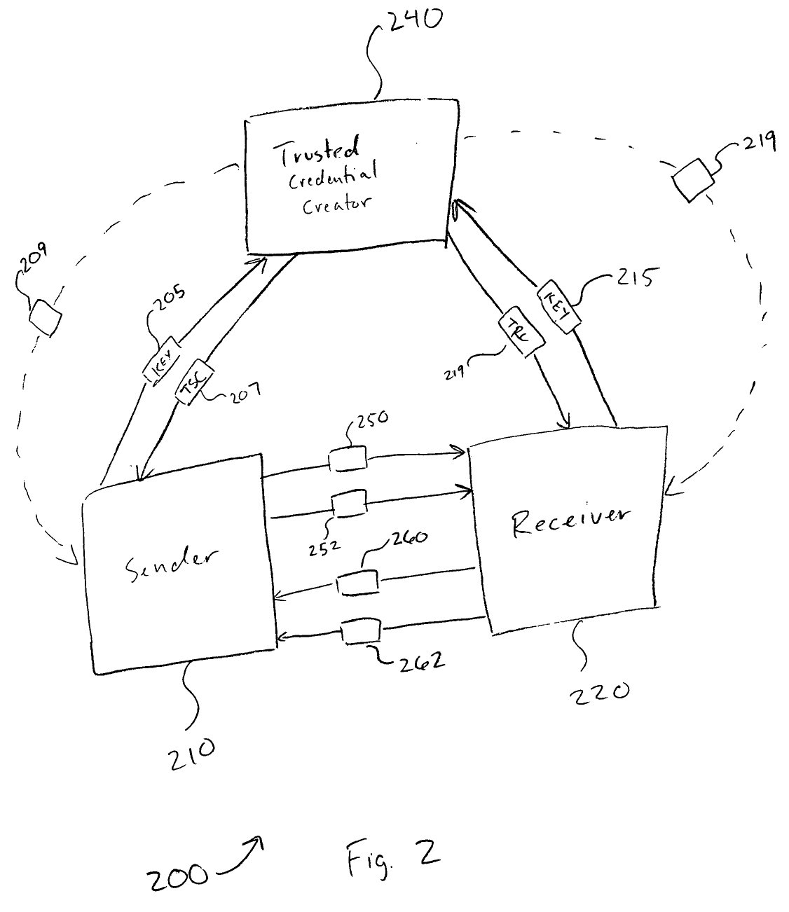

FIG. 2 illustrates a system of secure information exchange 200 according to another embodiment of the present invention. The system 200 includes sender keys 205, receiver keys 215 a trusted sender credential 207, a trusted receiver credential 217, a sender keys independent verification 209, a receiver keys independent verification 219, a sender 210, a receiver 220, a trusted credential creator 240, a secure file 250, a secure file 260, a trusted sender credential 252 and a trusted receiver credential 262.

In a second simplified example, a sender 210 may send a secure file 250 to a receiver 220 similar to the system 100 described above by FIG. 1. Specifically, the sender 210 may request a trusted sender credential 207 from the trusted credential creator 240. Likewise, the trusted credential creator 240 may request the sender keys 205 from the sender 210. If the sender 210 confirms the sender keys independent verification 209, the trusted credential creator may send the trusted sender credential 207 to the sender 210. Additionally, the sender 210 may send the secure file 250 and the trusted sender credential 252 to the receiver 220.

In addition, in the system 200 of FIG. 2, the receiver 220 may send a secure file 260 to the sender 210. The receiver 220 may originate a file that is to be protected. For example, a file may be originated at the receiver 220 by using a word processing program at the receiver 220, or other file origination program. Alternatively, a file may be passed to the receiver 220 for secure transmission to the sender 210, as further described below. The sender 210 may receive and access the secure file 260 originating from sender receiver 220.

Trusted credential creator 140 may provide receiver 220 with a trusted receiver credential 217. The trusted receiver credential 217 may protect a file originating from the receiver 220 and sent to the sender 210. As shown below, the trusted receiver credential 217 may confirm the identity of the receiver 220. The trusted receiver credential 217 may also confirm that a file originating from the receiver 220 has not been accessed or altered by anyone other than the receiver 220.

As shown in FIG. 2, the sender 210 is in communication with the receiver 220. The sender 210 and the receiver 220 are also in communication with the trusted credential creator 140.

In operation, sender 210 may transmit a secure file 250 from the sender 210 to receiver 220. Additionally, receiver 220 may send a secure file 260 from the receiver 220 to the sender 210. In a second, simplified example, the receiver 220 may request a trusted receiver credential 217 from the trusted credential creator 240. In response, the trusted credential creator 240 may request receiver keys 215 from the receiver 220. The receiver keys 215 may include encryption or digital signing keys. In the second simplified example, the receiver 220 provides the receiver keys 215 to the trusted credential creator 240.

After receiving the receiver keys 215, the trusted credential creator 240 may send receiver keys independent verification 219 to the receiver 220. As shown further below, the receiver keys independent verification 219 is sent to the receiver 220 to confirm that the receiver 220 is the source of the receiver keys 215. If the receiver 220 confirms the receiver keys independent verification 219, the trusted credential creator 240 may create the trusted receiver credential 217 as further shown below. After creating the trusted receiver credential 217, the trusted credential creator 240 may send the trusted receiver credential 217 to the receiver.

Continuing with the second, simplified example, at the receiver 220, a file or other data is identified that is to be transmitted from the receiver 220 to the sender 210. The file or other data is used by a receiver host application to generate a secure file 260. The secure file 260 includes data derived from the original file and also includes digital certificate information (such as a digital certificate and/or a digital signature), and/or metadata. The secure file 260 may also include data from the secure file 250 sent from sender 210 to receiver 220.

The receiver 220 may send the secure file 260 and the trusted receiver credential 260 to sender 210. The sender 210 may receive the secure file 260 and the trusted receiver credential originating from the receiver 220. Additionally, a sender host application may use the trusted receiver credential 262 to verify the contents and origin of the secure file 260 as further described below.

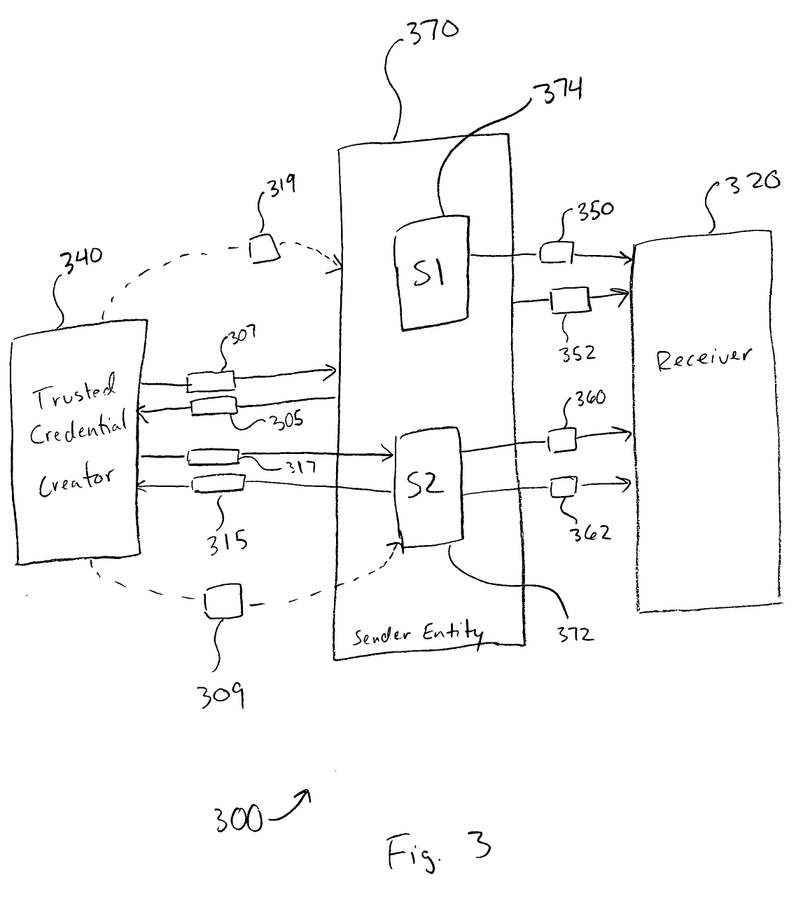

FIG. 3 illustrates a system of secure information exchange 300 according to another embodiment of the present invention. The system 300 includes a trusted credential creator 340, a receiver 320, a sender entity 370, a first individual sender 372, a second individual sender 372, sender entity keys 305, second individual sender keys 315, trusted sender entity credential 307, trusted second individual sender credential 317, a sender entity keys independent verification 309, a second individual sender keys independent verification 319, a secure file 350, a secure file 360, a trusted sender entity credential 352, and a trusted second individual sender credential 362.

In a third simplified example, the secure files 350 and 360 may be sent to receiver 320 similar to the systems 100 and 200 described above. More specifically, in system 300, the sender entity 370 includes a first individual sender 372 and a second individual sender 374. In one example, the sender entity 370 may be a corporation and the first individual sender 372 and the second individual sender 374 may be individuals employed by the corporation. Alternatively, the first individual sender 372 may be a department within a corporation and the second individual sender 374 may be a computer program run by a corporation. In a third, simplified example, the first individual sender 372 may send the secure file 350 to the receiver 320. Additionally, the second individual sender 374 may send secure file 360 to the receiver 320.

As in the previous examples, the trusted credential creator 340 may provide trusted sender credentials to senders. Specifically, in the third, simplified example, the trusted credential creator 340 may provide a trusted sender entity credential 307 and a trusted second individual sender credential 317. The sender entity 370 may use trusted sender entity credential 307 to send secure files. Additionally, individual senders such as the first individual sender 372 and the second individual sender 374 may also use the trusted sender entity credential 307 to send secure files. Alternatively, the first individual sender 372 and the second individual sender 374 may also obtain their own trusted individual sender credentials. For example, the second individual sender 374 may use trusted sender credential 317 to send secure files.

Similar to the examples described above, senders may request trusted sender credentials from the trusted credential creator 340. As shown in FIG. 3, the sender entity 370 and the second individual sender 374 may request trusted sender credentials from the trusted credential creator 340. The trusted credential creator 340 may request sender entity keys 305 from the sender entity 370. The trusted credential creator 340 may also request second individual sender keys 315. The sender entity keys 305 and second individual sender keys 315 may include one or more encryption and/or digital signing keys related to the digital signature of sender entity 370 and second individual sender 374. The sender entity 370 and the second individual sender 374 may send the sender entity keys 305 and the second individual sender keys 315 to the trusted credential creator 340.

After receiving the sender keys, the trusted credential creator verifies the source of the sender keys. For example, the trusted credential creator 340 may send the sender entity keys independent verification 309 to the sender entity 370 to confirm that the sender entity 370 is the source of the sender entity keys 305. The sender entity keys independent verification 309 may take several forms. For example, the initial request for a trusted sender entity credential 307 may include a telephone number that allows the trusted credential creator 340 to speak directly with the second individual sender 374 and confirm that the keys received by the trusted credential creator 340 were transmitted by sender entity 370. The sender entity keys independent verification 309 may also take place via e-mail or postal service. Other forms of sender entity keys independent verification 309 include transmitting a password, code, or account number. Another form of sender entity keys independent verification 309 relates to in-person or face-to-face identification of a sender. For example, a person associated with the trusted credential creator 340 may meet with a person associated with the sender entity 370 to verify the identity of the sender entity 370 and to confirm that the sender entity 370 has requested a trusted sender credential. Furthermore, the person associated with the trusted credential creator 340 may travel to a physical location associated with the sender entity 370 to perform the in-person sender entity keys independent verification 309. Examples of a physical location associated with the sender entity 370 include places of business and corporate offices. In another example, the person associated with the trusted credential creator 340 may travel to the physical location of the sender entity 370 to set up a process by which the sender entity 370 may create trusted sender credentials.

If the sender entity 370 confirms the sender entity keys independent verification 309, the trusted credential creator 340 may create the trusted sender entity credential 307 as further shown below. Additionally, the trusted credential creator 340 may also send the second individual sender keys independent verification 319 to the second individual sender 374 to confirm that the second individual sender 374 is the source of the second individual sender keys 315. If the second individual sender 374 confirms the second individual sender keys independent verification 319, the trusted credential creator 340 may create the trusted second individual sender credential 317 as further shown below. The trusted sender entity credential 307 and the trusted second individual sender credential 317 include digital certificate information (such as a digital certificate and/or a digital signature) identifying the sender entity 370 and the second individual sender 374.

After creating the trusted sender entity credential 307 and the trusted second individual sender credential 317, the trusted credential creator 340 may send the trusted sender entity credential 307 and the trusted second individual sender credential 317 to the sender entity 370 and the second individual sender 374.

The trusted sender entity credential 307 may protect a file originating from the sender entity 370, or a sub-division with the sender entity 370, sent to the receiver 320. For example, the sender entity 370, the first individual sender 372, and the second individual sender 374 may all use the trusted sender entity credential 307 to send the secure file 350 to the receiver 320. In another example, the second individual sender 374 may use the trusted second individual sender credential 317 to send the secure file 360 to the receiver 320.

Specifically, similar to the examples described above, a sender host application of first individual sender 372 may use a trusted sender entity credential 307 to generate a secure file 350. The secure file 350 may include files, folders, a digital certificate, and/or other data. As further shown below, the trusted sender entity credential 307 may confirm the identity of the sender entity 370. The trusted sender entity credential 307 may also confirm that a file originating from the first individual sender 372 has not been accessed or altered by anyone other than the first individual sender 372.

In another embodiment, a sender host application of second individual sender 374 may use a trusted second individual sender credential 317 to generate a secure file 360. The secure file 360 may include files, folders, a digital certificate, and/or other data. The trusted second individual sender credential 317 may confirm the identity of the second individual sender 374. The trusted second individual sender credential 317 may also confirm that a file originating from the second individual sender 374 has not been accessed or altered by anyone other than the second individual sender 374.

The first individual sender 372 may send the secure file 350 and the trusted sender entity credential 352 to receiver 320. Additionally, the second individual sender 374 may also send the secure file 360 and the trusted second individual sender credential 362 to receiver 320.

In an alternative embodiment, the trusted credential creator may send the trusted sender entity credential 307 and the trusted second individual sender credential 317 to the trusted credential creator 340.

The receiver 320 may receive the secure file 350, the trusted sender entity credential 352, the secure file 360, and the trusted second individual sender credential 362. The receiver host application may use the trusted sender entity credential 352 or trusted sender entity credential 307 to verify the contents and origin of the secure file 350 as further described below. Additionally, the receiver host application may use the trusted second individual credential 362 or trusted second individual credential 317 to verify the contents and origin of the secure file 360.

Once the secure file 350 and the trusted sender entity credential 352 are received by the receiver 320, the receiver 320 activates a receiver host application that then retrieves digital certificate information (such as a digital certificate and/or a digital signature) from the trusted sender entity credential 352 and digital certificate information from the secure file 350. The receiver host application then compares the digital certificate information from the trusted sender entity credential 352 and the digital certificate information from the secure file 350 to confirm that the digital certificates match. If the digital certificates match, then the receiver host application provides access to the secure file 350. Conversely, if the digital certificates do not match, then access is not provided to the secure file 350. The receiver host application also compares the digital certificate information from the trusted second individual sender credential 362 and the secure file 360. If the digital certificates match, then the receiver host application provides access to the secure file 360. Conversely, if the digital certificates do not match, then access is not provided to the secure file 360.

In one embodiment, the receiver 320 is a customer of a bank. The bank may be interested in sending information regarding the customer's financial transactions in a secure, confidential file format. The customer is interested in ensuring that the information received actually originated from the bank. For example, the customer may want to ensure a sender impersonating the bank did not send the financial information. Further, the customer desires to send the bank information on financial accounts held with the bank. The customer requires that this information be encrypted so that only the bank may decrypt the information exchange.

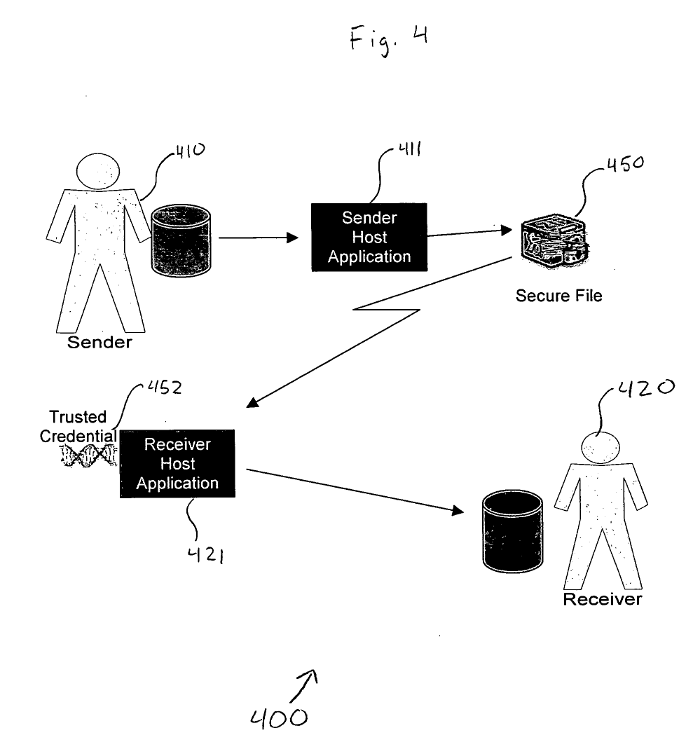

FIG. 4 illustrates a system for the transmission of a secure file 400 according to an embodiment of the present invention. The system 400 includes a sender 410, a sender host application 411, a trusted sender credential 452, a receiver 420, a receiver host application 421, and a secure file 450.

The sender host application 411 and the receiver host application 421 may perform the security and verification aspects of the system 400. More specifically, as further described below, the sender host application 411 may be used to generate the secure file 450 for transmission to the receiver 420. Additionally, the receiver host application 421 may operate to verify the contents and origin of the secure file 450 as further described below. As shown in FIG. 4, the sender 410 and the sender host application 411 are in communication with the receiver 420 and the receiver host application 421.

A host application may be a computer software program capable of reading or writing a secure file. A host application may run on any computer operating system or computing platform. One example of a computer operating system on which a host application may run is IBM System z. Other examples of computer operating systems on which a host application may run include Microsoft Windows, Microsoft Windows Smartphone, Palm OS, Linux, Unix, and Apple OS X. An example of a computing platform is IBM z900. Other examples of a computing platform on which a host application may run include personal computers, portable laptop computers, cell phones, smart phones, and PDAs. Other operating systems and computing platforms may be used to run the host application. The sender, receiver, and trusted credential creator may use a variety of computing platforms. The secure file and the host applications may also operate on different computing platforms.

A host application may operate from an operating system command prompt. Alternatively, the host application may operate from a script or batch processing environment. Alternatively, a host application may operate interactively using windows, dialogs, menus and toolbars.

In operation, the sender host application 411 provides sender 410 with several functions. For example, the sender 410 provides the sender host application 411 with files, folders, and/or metadata to include in secure file 450. The sender 410 also provides the sender host application with receiver 420 of the secure file 450.

The sender host application 411 will then create secure file 450. During the creation of secure file 450, the sender host application 411 can compress, encrypt, and digitally sign the secure file 450. The sender host application 411 also allows the sender 410 to modify the contents of the secure file 450 after creation. The sender host application 411 operates to send the secure file 450 from the sender 410 to the receiver 420.

The receiver host application 421 provides receiver with several functions. The receiver host application 421 operates to receive a secure file 450 sent from the sender 410 to the receiver 420. The receiver host application 421 allows a receiver to access the files, folders, and/or metadata contained in the secure file. Additionally, the receiver host application 421 can authenticate, decrypt, and decompress the secure file 450. The receiver host application 421 authenticates the secure file 450 by comparing a digital certificate contained in the secure file 450 to a digital certificate contained within the trusted sender credential 452. The receiver host application 421 may only provide the receiver 420 with access to the secure file 450 if the digital certificate contained in the secure file 450 matches the digital certificate contained within the trusted sender credential 452. The receiver host application 421 may not provide the same functionality as the sender host application 411. For example, the receiver host application may not provide the ability to create a secure file 450. In one embodiment, the sender host application 411 may restrict the functionality of receiver host application 421 as further described below. The sender host application 411 and the receiver host application 421 may provide other functionality as well.

The secure file 450 provides for file archiving, data compression, data encryption and digital signing. The secure file 450 is a file in the form of a ZIP archive. File archiving is a method for placing one, or more files or folders into another single file for storage or transfer. Combining many files and folders into a separate single file makes managing sets of files easier as it is easier to store or move the set of files as a single unit. A ZIP archive is a portable file format that allows for files and folders to be placed into a single file that may easily be moved between computer systems. Other secure file formats may be used.

In an alternate embodiment, sender 410 transmits a secure file 450 to a plurality of receivers. In another embodiment, the sender 110 may also utilize a sender host application to create secure file 450 through a computer process. One example of a computer process that creates secure file 450 is a computer program on a first computer that reads data from a computer database storage facility. After reading data from a computer database storage facility, the computer program uses a host application to create secure file 450. After secure file is created, the computer program on a first computer connects to a computer program on a second computer. A computer program such as FTP may be used to connect the first and second computer together. After the two computers are connected, the secure file 450 is sent to the receiver 420.

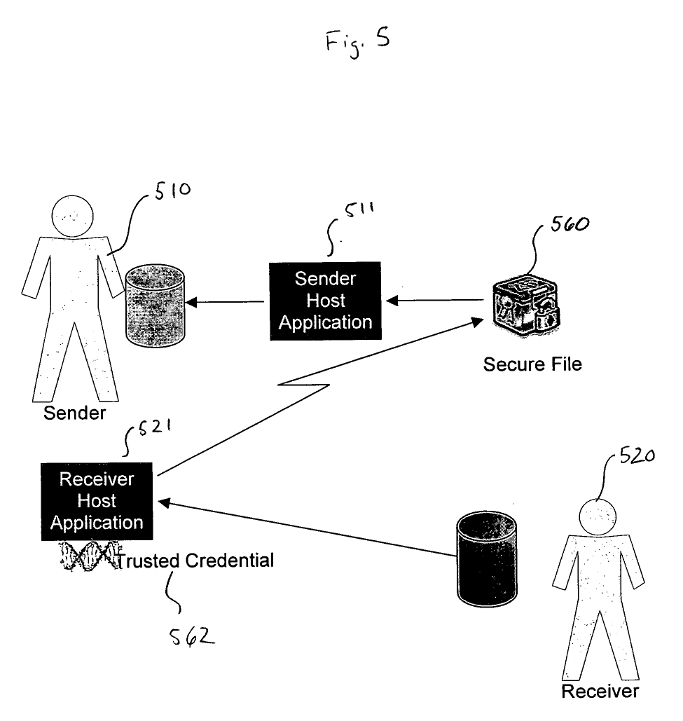

FIG. 5 illustrates a system for the transmission of a secure file 500 according to an embodiment of the present invention. The system 500 includes a sender 510, a sender host application 511, a trusted receiver credential 462, a receiver 520, a receiver host application 521, and a secure file 560. The system 500 operates similar to the system 400 described above. As shown in FIG. 5, the sender 510 and the sender host application 511 are in communication with the receiver 520 and the receiver host application 521.

In operation, the receiver host application 521 provides receiver 510 with several functions. For example, the receiver 510 provides the receiver host application 521 with files, folders, and/or metadata to include in secure file 560. The files, folders, and/or metadata may have originated from the sender 510 in an earlier received secure file. The receiver host application 521 will then create the secure file 560. During the creation of secure file 560, the receiver host application 521 can compress, encrypt, and digitally sign the secure file 560. The receiver host application 521 operates to send the secure file 560 from the receiver 520 to the sender 510. The sender host application 510 may operate similar to the receiver host application illustrated above in FIG. 4.

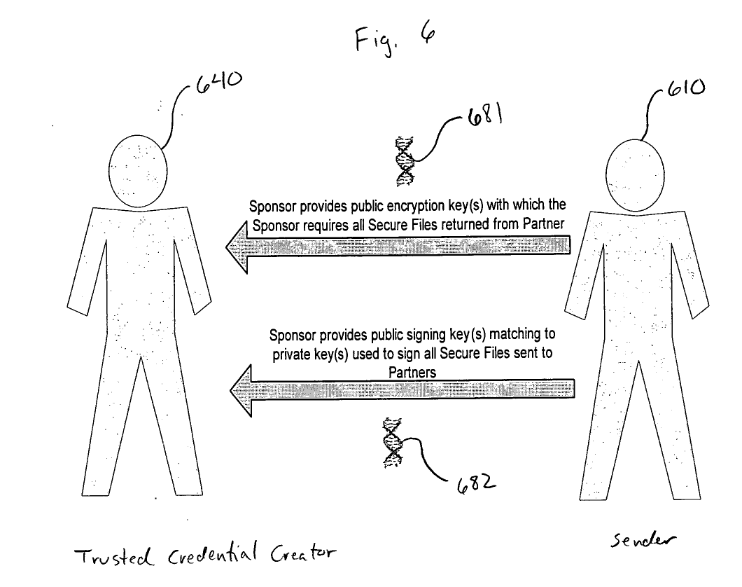

FIG. 6 illustrates a transfer of public keys from a sender to a trusted credential creator according to an embodiment of the present invention. FIG. 6 includes a trusted credential creator 640, a sender 610, public encryption key 681, and public signing key 682. The sender 610 may also be known as a sponsor. The trusted credential creator 640 may also be known as a trusted third party. As shown in FIG. 6, the sender 610 and the trusted credential creator 640 are in communication with each other.

The trusted credential creator 640 authenticates or verifies the sender 610 as a trusted source. The trusted credential creator 640 may be an individual or an entity such as a corporation. One example of a trusted credential creator 640 is PKWARE, Inc., the assignee of the present application. The trusted credential creator 640 authenticates the sender 640 as a trusted source by providing a trusted sender credential. The trusted credential creator may also provide host applications such as a sender host application and a receiver host application. These host applications create, send, receive, and access secure files.

In operation, the sender 610 requests a trusted sender credential from trusted credential creator 640. Next, the trusted credential creator 640 requests one or more keys from the sender 610. In response, the sender 610 sends the public encryption key 681 and the public signing key 682 to the trusted credential creator 640. The trusted credential creator 640 uses the public encryption key 691 and the public signing key 682 to create a trusted sender credential as further described below. The public encryption key 681 and public signing key 682 contained within the trusted sender credential are used to facilitate secured transfers of information. For example, a sender uses a sender host application to create a secure file. The secure file is signed with the public signing key 682 and sent to a receiver. The receiver also receives a trusted sender credential from the trusted credential creator 640 containing the public signing key 682. The receiver operates a receiver host application that compares the public signing keys to verify the source of the secure file. After accessing the secure file, the receiver can modify the contents of the secure file and return the secure file to the sender 610. The receiver host application encrypts the secure file with the public encryption key 682 before transferring the secure file to the sender 610.

In alternative embodiments, there may be a plurality of the public encryption key 681 and a plurality of the public signing key 682. Furthermore, a receiver may send a public encryption key and a public signing key to the trusted credential creator 640 to establish a trusted receiver credential as further described below.

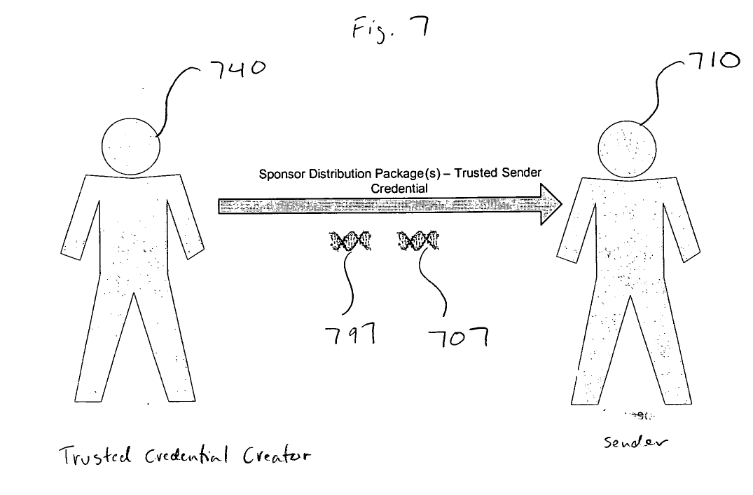

FIG. 7 illustrates a transfer of trusted sender credentials from a trusted credential creator to a sender according to an embodiment of the present invention. FIG. 7 includes a trusted credential creator 740, a sender 710, a first trusted sender credential 707, and a second trusted sender credential 797. The sender 710 may also be known as a sponsor. The trusted credential creator 740 may also be known as a trusted third party. As shown in FIG. 7, the sender 710 and the trusted credential creator 740 are in communication with each other. The trusted credential creator 740, the sender 710, the first trusted sender credential 707, and the second trusted sender credential 797 operate similar to examples described above and below.

The sponsor distribution packaging tool operates to create the first trusted sender credential 707 and second trusted sender credential 797. The sponsor distribution package packaging tool is a software application that packages at least one public signing key and at least one public signing key from the sender 710 in a trusted sender credential. The trusted sender credential may alternatively be known as a sponsor distribution package. The operation of the sponsor distribution package packaging tool is further described below. In operation, the trusted credential creator 740 may operate the sponsor distribution package packaging tool to create more than one trusted sender credential for the sender 710. For example, the trusted credential creator may send a first trusted sender credential 707 and a second trusted sender credential 797 to sender 710.

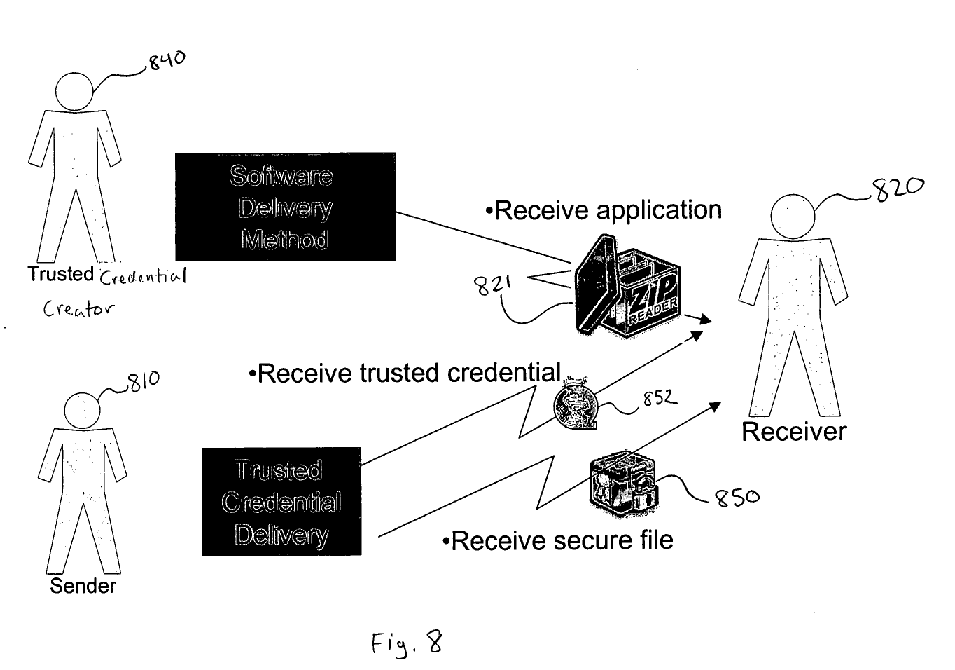

FIG. 8 illustrates a transfer of a trusted sender credential and a receiver host application according to an embodiment of the present invention. FIG. 8 includes a trusted credential creator 840, a sender 810, a receiver 820, a trusted sender credential 852, a receiver host application 821, and a secure file 850. As shown in FIG. 8, the sender 810 and the receiver 820 are in communication with each other. Additionally, the trusted credential creator 840 and the receiver 820 are also in communication with each other.

In operation, the trusted credential creator 840 transfers a receiver host application 821 to the receiver 820. Additionally, the sender 810 transfers a trusted sender credential 852 and a secure file 850 to the receiver 820. The receiver 820 operates the receiver host application 821. The receiver host application 821 operates to provide access to the secure file 850. Specifically, the receiver host application compares digital certificate information contained in the secure file 850 with digital certificate information contained in the trusted sender credential 852. If the digital certificates match, the receiver host application 821 provides the receiver 820 with access to the secure file 850. If the digital certificates do not match, the receiver host application 821 will not allow the receiver 820 to access the secure file 850.

The digital certificates may be in the form of public signing keys. The digital certificates may also be in the form of X.509 certificates, PGP certificates, or any other suitable certificate utilizing public and private keying.

The receiver host application 821 may not provide the same functionality as a sender host application. The sender 810 may restrict the ability of the receiver 820 to use certain functions of the receiver host application 821. For example, sender 810 may restrict the receiver host application 821 to only allow the receiver 820 to open and read the secure file 850 from sender 810. That is, sender 810 may also restrict the ability of the receiver 820 to use the receiver host application 821 to create secure files. The receiver host application 821 may be limited to only create secure files encrypted with the public encryption key of the sender 810. The sender may restrict the functionality of the receiver host application 821 through the trusted sender credential 852 as further described below.

In one embodiment, the receiver 820 copies the trusted sender credential 852 onto a computer. The receiver 820 selects trusted sender credential 852 using a computer mouse and drops trusted sender credential 852 onto receiver host application 821. The receiver 820 can also use a file selection function that is provided within the windows, menus and dialogs of the receiver host application 821 to select a trusted sender credential 852.

The receiver host application 821 authenticates the digital signature of the trusted credential creator 840 contained in a trusted sender credential 852 using a digital certificate of trusted credential creator 840 contained within the receiver host application 821. If the receiver host application 821 authenticates the digital signature of trusted credential creator 840, then the receiver host application 821 compares a first digital certificate in the trusted sender credential 852 to the digital certificate that was used to digitally sign secure file 850. The secure file 850 may be digitally signed with more than one digital certificate. If the secure file 850 has been digitally signed and a first digital certificate of secure file 850 does not match the digital certificate in the trusted sender credential 852, then the receiver host application 821 may compare each digital certificate in the secure file 850 to the digital certificate in the trusted sender credential 852 until a match is found. Additionally, trusted sender credential 852 may contain more than one digital certificate. If the secure file 850 has been digitally signed and a digital certificate of the secure file 850 does not match a first digital certificate in the trusted sender credential 852, then receiver host application 821 may compare the digital certificate in the secure file 850 to each digital certificate in the trusted sender credential 852 until a match is found.

Additionally, the receiver host application 821 may prevent access to the secure file 850 under other conditions. For example, if the receiver host application 821 cannot locate a trusted sender credential 852 for sender 810, then the receiver host application 821 may prevent the receiver 820 from accessing the secure file 850. If the digital signature of the trusted sender credential 852 is not authenticated to the identity of trusted credential creator 840 that issued the trusted sender credential 852, the receiver host application 821 may end operation and the receiver 820 cannot access the secure file 850. In another example, if the secure file 850 was not signed, the receiver host application 821 will not allow the receiver 820 to access the secure file 820. In another alternate embodiment, receiver 820 accepts sender 810 a trusted source before receiving the secure file 850 as further described below. The process of sending a secure file described above may be referred to as a secure transmission.

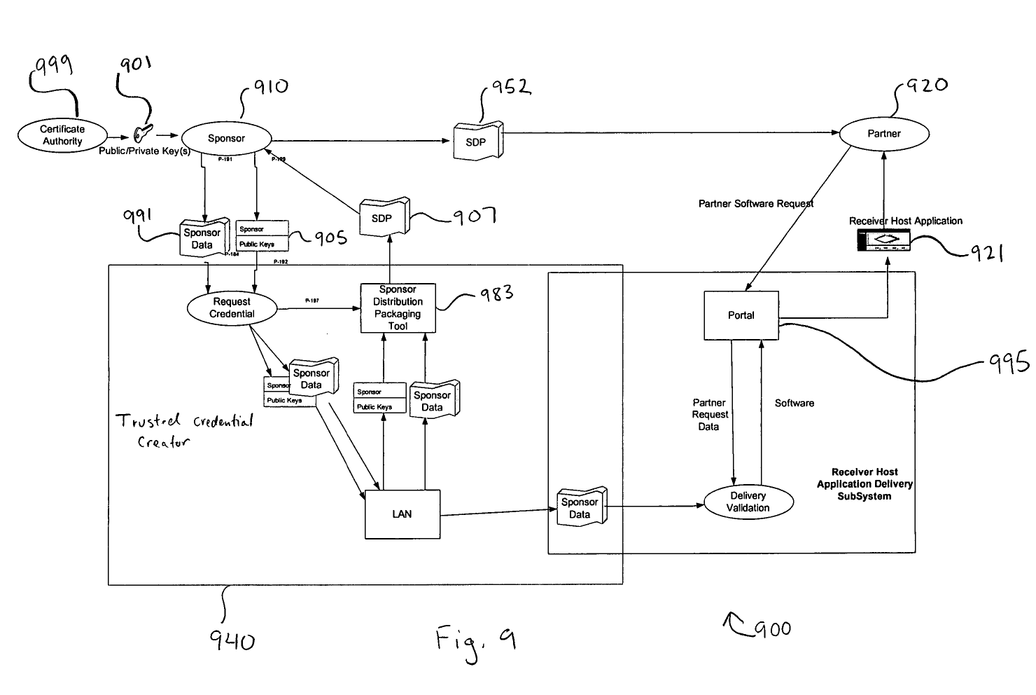

FIG. 9 illustrates a system of secure information transmission according to an embodiment of the present invention. The system 900 includes a sender 910, a receiver 920, a trusted credential creator 940, sender public keys 905, a trusted sender credential 907, a receiver host application 921, a trusted sender credential 952, a sponsor distribution packaging tool 983, a sender data file 991, a third party portal 995, a certificate authority 999, and certificate authority-sender keys 901.

As shown in FIG. 9, the sender 910, the receiver 920, the trusted credential creator 940, and the certificate authority 999 are all in communication with each other. Specifically, communication between the sender 910, the receiver 920, the trusted credential creator 940, and the certificate authority 999 may occur through ftp, http, https, ssh, e-mail, instant messaging, and/or a LAN. Additionally, the sender 910, the receiver 920, the trusted credential creator 940, and the certificate authority 999 may communicate through physical media such as CD-ROM, computer tape, flash drive or other physical media. One embodiment allows any method of file transfer to be used to exchange computer files between the sender 910, the receiver 920, the trusted credential creator 940, and the certificate authority 999. A secure file transferred from the sender 910 to the receiver 920 remains secure independent of the method of transfer.

In operation, the sender 910 requests a trusted sender credential from the trusted credential creator 940 similar to the examples provided above. Next, the trusted credential creator 940 requests one or more keys from the sender 910.

In response, the sender 910 contacts the certificate authority 999 to request the certificate authority-sender keys 901. The certificate authority 999 is an entity that issues digital certificates such as X.509 or PGP used to digitally sign files. A certificate authority may issued digital certificates utilizing any public/private or symmetric/asymmetric keying technique. Examples of certificate authority 999 include VeriSign, Inc., Thawte Consulting, and Comodo Group. The certificate authority 999 may also be a software application such as an encryption program. The certificate authority-sender keys 901 are keys used by the certificate authority 999 to create a digital certificate for the sender 910. The certificate authority-sender keys 901 may include public and private keys.

After receiving the certificate authority-sender keys 901, the sender 910 sends the sender public keys 905 to the trusted credential creator 940. The sender also sends the sender data file 991 to the trusted credential creator 940. The sender data file 991 includes instructions to restrict the functionality of the receiver host application 921 as further described below. The sender data file 991 may also be known as receiver control data.

The trusted credential creator 940 uses the sender public keys 905 to create a trusted sender credential 907. The trusted credential creator 940 activates the sponsor distribution packaging tool 983 to create the trusted sender credential 907. The sponsor distribution packaging tool 983 uses the sender public keys 905 from the sender 910 to create the trusted sender credential 907. Additionally, the sponsor distribution packaging tool 983 uses the sender data file 991 to limit the functionality of the receiver host application 921. For example, the sender data file 991 includes instructions that specify which instructions the receiver host application 921 may perform when the receiver host application 921 accesses a secure file from the sender 910. The sponsor distribution packaging tool 983 includes the instructions limiting the functionality of the receiver host application 921 when creating the trusted sender credential 907. The trusted credential creator 940 provides the trusted sender credential 907 to the sender 910. Then, the sender 910 provides the trusted sender credential 952 to the receiver 920.

Additionally, the receiver 920 requests a receiver host application similar to the examples provided above. The receiver 920 may communicate this request to the portal 995 of trusted credential creator or trusted third party. The portal 995 may handle requests from receivers requesting receiver host applications. The trusted credential creator uses the sender data file 991 to restrict the functionality of the receiver host application 921. More specifically, when receiver 920 requests a receiver host application, the portal 995 of the trusted credential creator 940 may check if sender 910 sent a sender data file 991 corresponding to the receiver 920 to the trusted credential creator 940. If the sender 910 sends a sender data file 991 corresponding to the receiver 920, the trusted credential creator 940 may use the sender data file 991 to restrict the functionality of the receiver host application 921. More specifically, the sender data file 991 may include options limiting the actions receiver host application can perform. The trusted credential creator 940 may utilize the options in the sender data file 991 to deliver a limited functionality version of the receiver host application 991. Alternatively, the trusted credential creator 940 may deliver a full functionality version of the receiver host application as well as the sender data file 991. The full functionality version of the receiver host application 921 will utilize the sender data file 991 to restrict the functions the receiver host application 921 may perform. In another alternative embodiment, the trusted sender credential 907 and the trusted sender credential 952 are the same trusted sender credential.

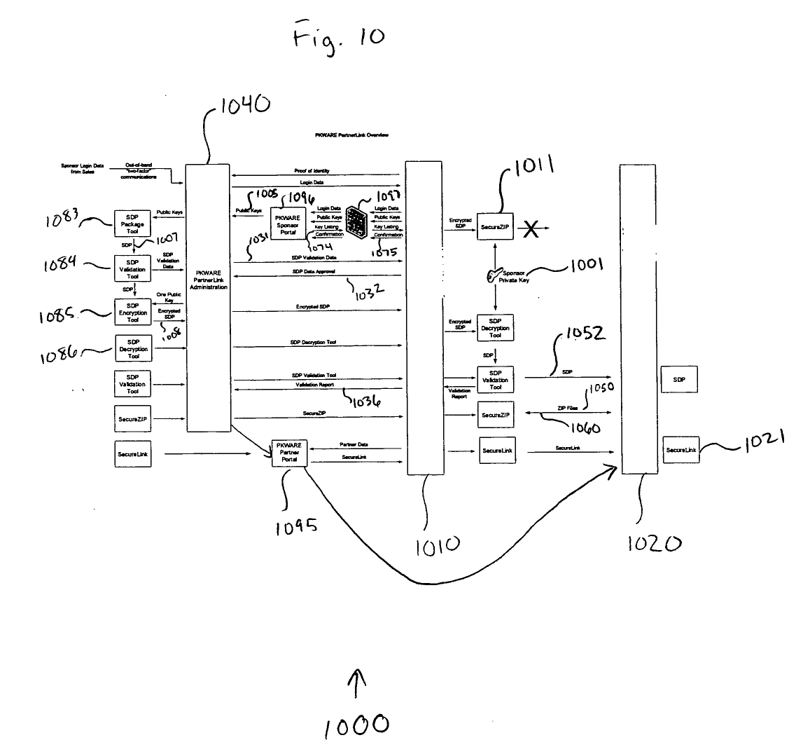

FIG. 10 illustrates a system of secure information transmission according to an embodiment of the present invention. The system 1000 includes a sender private key 1001, sender public keys 1005, a trusted sender credential 1007, an encrypted trusted sender credential 1008, a sender 1010, a sender host application 1011, a receiver 1020, a receiver host application 1021, a trusted sender credential validation data 1031, a trusted sender credential approval 1032, a trusted sender validation report 1036, a trusted credential creator 1040, a secure file 1050, a trusted sender credential 1052, a secure file 1060, a key listing 1074, a key verification 1075, a trusted sender credential packaging tool 1083, a trusted sender credential validation tool 1084, a trusted sender credential encryption tool 1085, a trusted sender credential decryption tool 1086, a receiver portal 1095, a sender portal 1096, and an authentication gateway 1097.

The system 1000 provides a more detailed example of an embodiment of the invention. Certain components of system 1000 may operate similar to embodiments described above. As shown in FIG. 10, the sender 1010, the receiver 1020, and the trusted credential creator 1040 are in communication with each other.

In operation, the sender 1010 transfers a secure file 1050 to the receiver 1020. More specifically, the sender 1010 uses the sender host application 1011 and the trusted sender credential 1007 to create a secure file 1050. The sender host application 1011 transfers the secure file 1050 to the receiver 1020. The receiver 1020 operates a receiver host application 1021 to receive and access the secure file 1050. Additionally, the receiver 1020 may operate the receiver host application 1021 to edit the secure file 1050 and transfer the edited secure file 1060 to the sender 1010. This process may be referred to as a secure transmission.

First, the sender 1010 requests a trusted sender credential from the trusted credential creator 1040 similar to the examples provided above. Additionally, the sender 1010 communicates the request for a trusted sender credential through the sender portal 1096 of the trusted credential creator 1040. The sender portal 1096 is an interface through which the sender 1010 may request sender credentials or host applications. The sender portal 1096 is a component of the trusted credential creator 1040. The sender portal may be a software application or a web page provided by the trusted credential creator 1040. Additionally, access to the sender portal 1096 may limited by the authentication gateway 1097. In that example, a sender must successfully answer a challenge from the authentication gateway 1097. One such challenge is a password prompt provided by the authentication. The sender 1010 is required to respond with the correct password before communicating with the sender portal 1096. Other examples of challenges provided by the authentication gateway 1097 include requesting an answer to a question, verifying a network address, or logging on to a web page through the https protocol. The proper response to a challenge may be unique to each sender. After successfully responding to a challenge from the authentication gateway 1097, the sender 1010 may communicate with the sender portal 1096.

After a request for a trusted sender credential from the sender 1010, the trusted credential creator 1040 requests one or more keys from the sender 1010. In response, the sender 1010 sends the sender public keys 1005 to the trusted credential creator 1040. After receipt of the public keys 1005, the trusted credential creator 1040 will attempt to verify the source of the public keys 1005. Specifically the trusted credential creator 1040 will transfer the key listing 1074 to the sender 1010. The key listing 1074 includes unique identifying information about the public keys 1005. Examples of identifying information for public keys 1005 include serial numbers, key length, creation date, creator, etc. The sender 1010 receives the key listing 1074. If the sender 1010 examines the key listing 1074 and determines it to be correct, the sender 1010 will respond by sending the key verification 1075 to the trusted credential creator 1040. After the key verification 1075 has been sent for public keys 1005, the public keys 1005 are said to be verified.

After receiving the key verification 1075, the trusted credential creator 1040 operates the sender public keys 1005 and the trusted sender credential packaging tool 1083 to create a trusted sender credential 1007. The public keys 1005 included in the trusted sender credential will be signed by a private signing key of the trusted credential creator 1040. The trusted sender credential packaging tool 1083 may also include the hash values of the public keys 1005 in the trusted sender credential 1007.

Next, the trusted credential creator 1040 may optionally use the trusted sender credential validation tool 1084 to verify the trusted sender credential 1007. The trusted sender credential validation tool 1084 sends the trusted sender credential validation data 1031 to the sender 1010. The trusted sender credential validation data 1031 includes the hash values of the public keys 1005 included in the trusted sender credential 1007. If the sender 1010 accepts the trusted sender credential validation data 1031, the sender responds with the trusted sender credential approval 1032.

Next, the trusted credential creator 1040 encrypts the trusted sender credential 1007 to create encrypted trusted sender credential 1008. There are a number of encryption algorithms compatible with embodiments of the invention, including asymmetric and symmetric key algorithms. Some examples of encryption algorithms that may be used by various embodiments include: Diffie-Hellman, DSS, ElGamal, RSA, SSL, PGP, GPG, Twofish, Serpent, AES, Blowfish, CAST5, RC4, RDES, SSH, SILC, IKE and IDEA. The encryption key used to encrypt the trusted sender credential 1007 will match a unique encryption key provided to the trusted credential creator 1040 by sender 1010. The encryption key may be a public encryption key included in the public keys 1005.

The trusted credential creator 1040 transfers the encrypted trusted sender credential 1008 and the trusted sender credential decryption tool 1086 to the sender 1010. The trusted credential creator 1040 may also transfer the sender host application to the sender 1010. The sender 1010 operates the sender host application to utilize the trusted sender credential 1007. In one embodiment, the trusted sender decryption tool 1086 decrypts the encrypted trusted sender credential 1008 to provide the trusted sender credential 1007. A certificate authority may provide the sender private key 1001 to the sender host application 1011 and the trusted sender decryption tool 1086. The trusted sender decryption tool 1086 utilizes the sender private key 1001 to decrypt the encrypted trusted sender credential 1008. After the trusted sender decryption tool 1086 decrypts the encrypted trusted sender credential 1008, the trusted sender decryption tool 1086 communicates with the trusted sender credential validation tool 1084. Specifically, the trusted sender decryption tool 1086 notifies the trusted sender credential validation tool 1084 that the encrypted trusted sender credential 1008 has been decrypted. In response, the trusted sender credential validation tool 1084 sends the trusted sender validation report 1036 to the trusted credential creator 1040. The trusted sender validation report 1036 establishes the sender 1010 as a trusted sender. The trusted sender 1010 operates sender host application 1011 to create a secure file 1050 utilizing the trusted sender credential 1007.

The trusted credential creator 1040 transfers the receiver host application 1021 to the sender 1010. The sender 1010 transfers the receiver host application 1021, the secure file 1050, and the trusted sender credential 1052 to the receiver 1020. Alternatively, the trusted credential creator 1040 may provide the receiver host application 1021 to the receiver 1020. A request for the receiver host application 1021 may be communicated to the receiver portal 1095. The receiver 1020 operates the receiver host application 1021 to receive the secure file 1050. The receiver host application 1021 utilizes the trusted sender credential 1052 to access the secure file. Additionally, the trusted sender credential 1052 may provide the receiver host application 1021 with the functionality to edit the secure file 1050 and create a secure file 1060. The receiver 1020 may operate the receiver host application 1021 to send the secure file 1060 to the sender 1010.

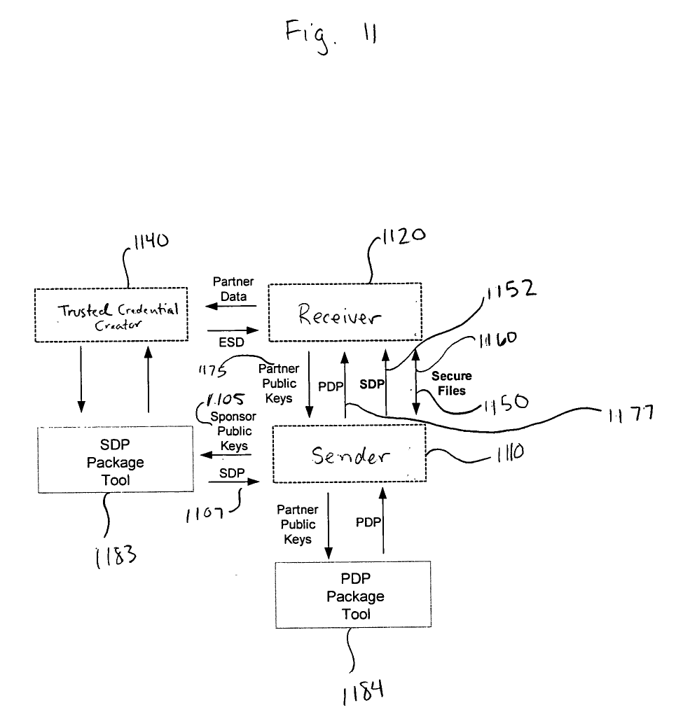

FIG. 11 illustrates a transfer of a trusted receiver credential from a sender according to an embodiment of the present invention. FIG. 11 includes a sender 1110, a receiver 1120, a trusted credential creator 1140, a secure file 1150, a secure file 1160, sender public keys 1105, a trusted sender credential 1107, a trusted sender credential 1152, receiver public keys 1175, a trusted receiver credential 1177, a trusted sender credential packaging tool 1183, and a trusted receiver credential packaging tool 1184. A sender may also be referred to as a sponsor. A receiver may also be referred to as a partner. As shown in FIG. 11, the sender 1110, the receiver 1120, and the trusted credential creator 1140 are in communication with each other.

In operation, a sender 1110 establishes a trusted sender credential 1107 similar to the examples described above. Specifically, the sender 1110 provides the sender public keys 1105 to the trusted credential creator 1140. The trusted credential creator 1140 operates the trusted sender credential packaging tool 1183 to create the trusted sender credential 1107. The trusted credential creator provides the trusted sender credential to the sender 1110. Additionally, the sender 1110 transfers the trusted sender credential 1152 and the secure file 1150 to the receiver 1120. As in the examples above, the trusted sender credential 1107 and the trusted sender credential 1152 may be the same trusted sender credential.

Additionally, the receiver 1120 may establish a trusted receiver credential. Specifically, the receiver 1120 requests a trusted receiver credential from the sender 1110. In response, the sender 1110 requests public keys from the receiver 1120. The receiver 1120 transfers the receiver public keys 1175 to the sender 1110. The sender 1110 operates the trusted receiver credential packaging tool 1184 to create the trusted receiver credential 1177. The sender 1110 transfers the trusted receiver credential 1177 to the receiver 1120. The receiver 1120 operates a receiver host application to utilize the trusted receiver credential 1177 to create a secure file 1160. The receiver 1120 transfers the secure file 1160 to the sender 1110.

In alternative embodiment, the trusted credential creator 1140 operates the trusted receiver credential packaging tool 1184 to create the trusted receiver credential 1177. The trusted credential creator 1140 may transmit a receiver host application to the receiver 1120 using Electronic Software Distribution. Examples of Electronic Software Distribution include ftp, http, and cd-rom.

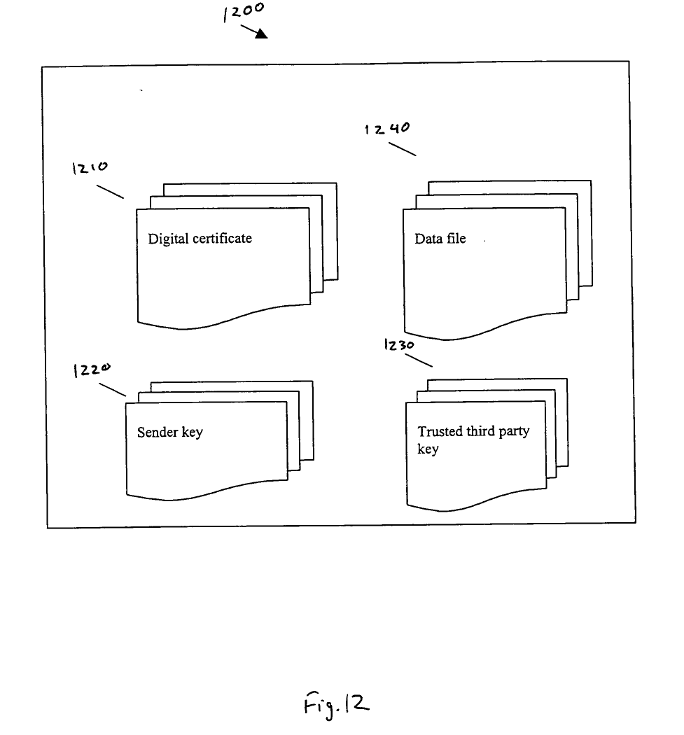

FIG. 12 illustrates a trusted sender credential according to an embodiment of the present invention. Trusted sender credential 1200 includes a digital certificate 1210, a sender key 1220, a trusted credential creator key 1230, and a data file 1240. The trusted sender credential 1200 is a digital document that uniquely identifies a sender of a secure file.

One example of digital certificate 1210 is an X.509 digital certificate. An X.509 digital certificate is one well-known form of a trusted credential that binds the identity of an individual or an organization to a digital document. The X.509 specification for digital certificates includes the use of a public and a private key. Another example of a digital certificate is PGP. In addition, any digital certificate utilizing public/private or symmetric/asymmetric keying techniques may be used. Digital signing is a technique of applying a digital signature to a computer file or to a ZIP archive. A digital signature is an electronic signature that records the exact content of a file at the time it was digitally signed. Further, a digital signature records the electronic identity of the individual or entity that signed the file, thus establishing trust in the sender. A digital signature may be applied to information in a secure file in the manner described for ZIP files in the Application Note or “APPNOTE” maintained by PKWARE, Inc., the assignee of the present application. The APPNOTE was most recently updated on Sep. 29, 2006 and is available at http://www.pkware.com/business_and_developers/developer/appnote/. The APPNOTE is hereby incorporated by reference in its entirety.

The sender key 1220 is any key used to encrypt or digitally sign a file. In one embodiment the sender key 1220 is a public key provided to a trusted credential creator or trusted third party. The trusted credential creator key 1230 is any key used to encrypt or digitally sign a file. In one embodiment, the trusted credential creator key is a private key used to sign the trusted sender credential 1200.

The data file 1240 contains information about the trusted sender credential 1200. The data file 1240 may include information about the sender public key 1220 and the trusted credential creator key 1230. Additionally, the data file 1240 may contain information restricting the functionality of a receiver host application. The data file 1240 may also contain various metadata relating to the trusted sender credential 1200 and the data contained in the trusted sender credential 1200. The trusted sender credential 1200 may also contain other types of information. The trusted sender credential 1200 may be in the form of a ZIP file.

The trusted sender credential 1200 may contain a plurality of digital certificates 1210. For example a group of individual senders could desire to create a sender organization. Each individual sender within the organization could provide a digital certificate for the trusted sender credential. The trusted sender credential for the organization would contain a digital certificate corresponding to each member of the sender organization.

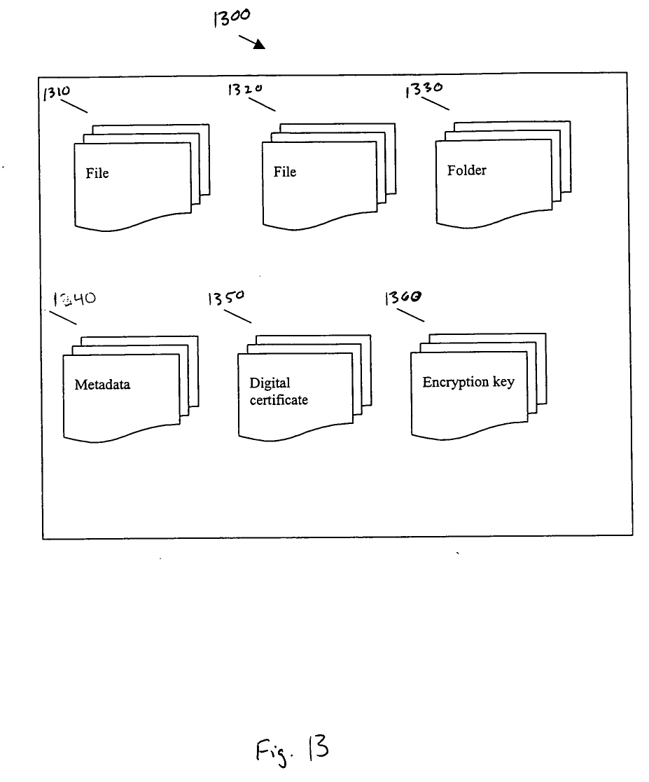

FIG. 13 illustrates a secure file according to an embodiment of the present invention. The secure file 1300 includes a file 1310, a file 1320, a folder 1330, metadata 1340, a digital certificate 1350, and encryption key 1360. The file 1310 and the file 1320 can be any type of computer files included in the secure file 1300. The folder 1330 may contain a plurality of computer files. The metadata 1340 contains metadata related to at least one of the file 1310, the file 1320, the folder 1330, or the secure file 1300. The secure file 1300 may also be created without metadata 1340. The digital certificate 1350 may be included to digitally sign the secure file 1300 and identify the creator, sender, or recipient of the secure file 1300. The digital certificate 1350 may also identify a trusted third party. The secure file 1300 may include a plurality of the digital certificates, including digital certificates from multiple sources. The secure file 1300 may also contain one or more encryption key 1360. The secure file 1300 may be encrypted or compressed. The secure file 1300 is a file in the form of a ZIP archive. Other secure file formats may be used.

The digital certificate 1350 may be applied to each file within the secure file 1300 or to cover all files as a single unit within secure file 1300. The digital signature 1350 may also be applied to each file within the secure file 1300 at the same time as the digital signature 1350 is applied to cover all of the files as a single unit within the secure file 1350.

In its most generic sense, metadata is data relating to data. In our specific context, metadata may include data about the files that are placed into the secure file 1350 that identify characteristics of those files within the secure file 1350. Also, preferably, the metadata characteristics of files within the secure file 1350 may be read from the secure file 1350. One example of metadata is the name of the file. Another characteristic about a file is the size of the file before being compressed by a data compression algorithm and placed into secure file 1350. Another characteristic about a file is the size of the file as it resides within secure file 1350 after being compressed by a data compression algorithm. Other characteristics of files may also be used.

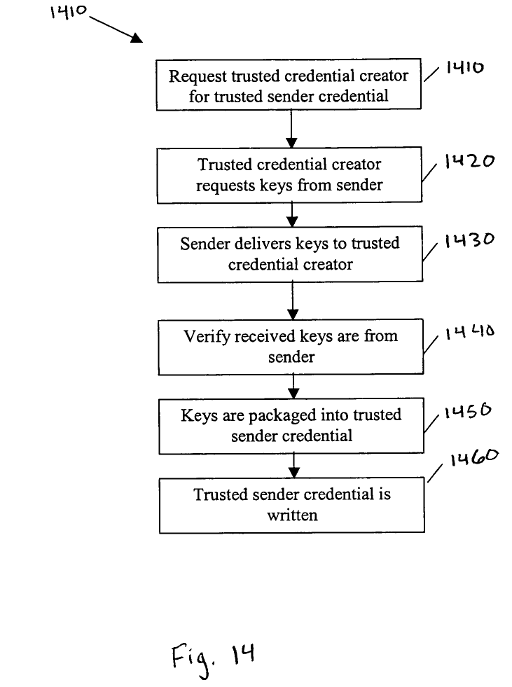

FIG. 14 illustrates a method of establishing a trusted sender credential 1400 according to an embodiment of the present invention. First, in step 1410 a sender contacts a trusted credential creator to request a trusted sender credential. A sender may use this trusted sender credential to sponsor the trusted exchange of information between a sender and a receiver. A sender may initiate the request of a trusted sender credential electronically, or through physical media.

Next, at step 1420, a trusted credential creator request keys from a sender. A trusted credential creator may request public signing keys such as an X.509 certificate or any other digital certificate used for digitally signing data. Further, a trusted credential creator may request from the sender public keys capable of decrypting encrypted data returned from the receiver. Other public keys may also be used.

Next, at step 1430, the sender delivers the keys to the trusted credential creator or trusted third party. Specifically, the sender may deliver one or more signing keys to the trusted third party. The sender may also deliver one or more encryption keys to the trusted third party. These encryption keys may be any key format suitable for encrypting or decrypting data. The signing keys and the encryption keys may be the same key. In one embodiment, the signing key and the encryption key may be delivered to a trusted credential creator using a secure internet file transfer protocol to protect the keys from exposure to an unauthorized receiver and to ensure the confidentiality of the request for the trusted credential by the sender. One example of a secure internet file transfer protocol to protect the keys is HTTPS. Other methods of delivering keys to a trusted credential creator may be used. One example of another method of delivering keys to a trusted credential creator it to use a file in the ZIP format that is encrypted using encryption methods as defined in the APPNOTE mentioned above.

After receiving the keys from the sender, at step 1440, the trusted credential creator will verify that each received key is from the sender. The trusted credential creator sends unique information relating to each received key to the sender and requests that the sender confirm the keys received by the trusted credential creator are the sender's keys. The sender verifies that the unique information sent by the trusted credential creator corresponds to the unique information relating to the sender's keys. The trusted credential creator may also confirm that the sender intended to receive a trusted sender credential from the trusted credential creator or trusted third party. Examples of unique information about a key include a serial number, key length, and date of creation. Other unique information may also be used. Verification of a key establishes trust in the holder of the key. Key verification may be performed electronically, by telecommunications, or through physical media. Verification may be performed in other ways.

Next, at step 1450, the trusted credential creator packages the sender's keys into a trusted sender credential by using a sponsor internal packaging interface. The sponsor internal packaging interface consists of a sponsor distribution package (SDP) packaging tool used to create a trusted sender credential.

The sponsor distribution package (SDP) packaging tool used by the sponsor internal packaging interface to create a trusted credential is a software program. The trusted sender credential may alternatively be known as a sponsor distribution package. The SDP packaging tool is operated by the sponsor internal packaging interface as follows. First, an input file is created in the format of an XML data file. Other file formats may be used. The content of the input file is as follows:

<sponsor name=“Name of sponsor” id=“id number”>

<comment>Comment from sponsor</comment>
<signer file=“certificate file containing Authorized Signer”/>
<signer_ca file=“certificate file containing CA certificates

for Authorized Signer”/>

<signer_root file=“certificate file containing root

certificates for Authorized Signer”/>

<recipient file=“certificate file containing Authorized

Recipients”/>

<recipient_ca file=“certificate file containing CA

certificates for Authorized Recipients”/>

<recipient_root file=“certificate file containing root

certificates for Authorized Recipients”/>

<crl file=“file containing CRL information for either signers

or recipients”/>

<output file=“name of file to be created by this program”/>
</sponsor>

Next, the trusted credential creator runs the SDP packaging tool using the sponsor internal packaging interface. The input file is provided to the SDP packaging tool as a command parameter. The SDP packaging tool opens and reads the contents of the input file and creates the trusted sender credential.

The SDP packaging tool places at least one trusted public key of the sender into a trusted sender credential file and signs the trusted sender credential file using a private key that uniquely identifies the trusted third party. A trusted key may also be described as a verified key. Additional trusted public keys of the sender may also be placed into the same trusted sender credential file that contains the first verified public key of the sender. Each additional trusted public key is also digitally signed using a private key that uniquely identifies the trusted third party. The trusted sender credential will also contain a least one Certificate Authority (CA) certificate. A Certificate Authority is an entity that issues digital certificates such as X.509 or PGP for use by other parties. One example of a trusted sender credential file is a file in the ZIP format. Other file formats may be used. One example of the contents of a trusted sender credential is as follows:

TABLE 1

| Name | Description |
|---|---|
| sponsor.xml | Configuration information for the sponsor in XML format |
| auth.p7b | Collection of certificates that will be used as signers |
| | for archives created by the sponsor. This store will |
| | contain end-entity certificates and CA certificates |
| | needed to build the trust chains for them. |
| recip.p7b | Collection of certificates that will be used as |
| | recipients and contingency key(s) for archives sent |
| | back to the sponsor. This store will contain end-entity |
| | certificates and CA certificates needed to build the |
| | trust chains for them. |
| crl.p7b | Collection of certificate revocation lists |
| auth-ca.p7b | Future: Collection of CA certificates that could |
| | issue certificates that would be trusted for |
| | extraction by reader. |

The trusted sender credential file may restrict the functionality of a receiver host application. For example the trusted sender credential file may only allow the receiver host application to access secure files from the sender. Alternatively, the trusted sender credential file may allow the receiver host application to create an encrypted secure file to transfer to the sender. The trusted sender credential file may restrict the receiver host application based on the keys the sender includes in the trusted sender credential file.

Additionally, the SDP packaging tool places a data file into the trusted sender credential file. The data file contains information about a sender and about the public keys of the sender that are contained in the trusted sender credential. One example of information included in the data file is the hash of each public key contained in the trusted sender credential. The hash of each public key is recorded to ensure that trusted keys are contained in the trusted sender credential file. The data file may also include a comment to record information for the receiver. The data file may also include a date value to record when the trusted credential creator created the trusted sender credential file for the sender. The SDP packaging tool may also place a unique identifier for the sender into the data file. The trusted credential creator assigns the unique identifier for the sender.

The SDP packaging tool may also write a type value into the data file of the trusted sender credential. The type value may be included to restrict the functions that the receiver may perform with the receiver host application. For example, the receiver may be restricted to only accessing secure files from the sender. Alternatively, the receiver may be allowed to access files from the sender and also to send secure files back to the sender. In an alternative embodiment, the type value may be placed anywhere within the trusted sender credential. In another embodiment, this type value may be stored in the receiver host application sent to the receiver.

The SDP packaging tool may also include other information in the data file stored in the trusted sender credential. One format for the data file may be XML. Other formats may also be used. The data file will be digitally signed using the private key of the trusted credential creator when it is placed into the trusted sender credential file. One example of the XML data file is as follows:

<sponsor version=“1” id=“99” name=“PKWARE PartnerLink Network”
type=“0” files=“0x1” flags=“0x0” creation_date=
“2006-09-06 20:49:22”>

<auth_list>

<pk_hash>
982ABCDXYZ92929292B2620BDF66EA132DEC3B787
</pk_hash>
<pk_hash>
123456789ABCDEF123456789ABCEDF123456789ABC
</pk_hash>

</auth_list>
<comment>
PKWARE PartnerLink Sponsor Distribution Package
</comment>

</sponsor>

| Field | Description |
|---|---|
| version | Sponsor File version number |
| id | PKWARE assigned unique sponsor identifier. This |
| | would be an incrementing integer starting at 1. |
| name | Unique name of the sponsoring organization |
| type | Determines what type of license the sponsor |
| | purchased, according to the following values: |
| | 0 - Reader only |
| | 1 - Reader Responder |
| files | Bit mask that determines what files are present |
| | within the sponsor file according to the following |
| | values: |
| | 0x01 - auth.p7b |
| | 0x02 - recip.p7b |
| | 0x04 - crl.p7b |
| | 0x08 - auth-ca.p7b |
| flags | Additional processing bit flags. All values would be |
| | reserved for future use at this time but it would give |
| | us an easy way to add simple flags down the road |
| creation_date | Date that the sponsor file was created. This could |
| | be used to identify cases were a user attempted to |
| | install an older version of the sponsor file on the |
| | system. |
| comment | Contains an optional sponsor provided comment. |

Next, at step 1460, the SDP packaging tool writes the trusted sender credential for the sender. SDP packaging tool writes the trusted sender credential as a ZIP file. The trusted sender credential has a name that uniquely identifies the sender. Specifically, the format of the file name of the trusted sender credential will be composed of a numeric value matching to the unique identifier for the sender that was assigned by the trusted credential creator or trusted third party. Additionally, the trusted sender credential file has a file name extension of .DAT. In alternative embodiments, other file types, names, and extensions may be used. The .DAT file that results from the above steps is the trusted sender credential file for the sender. In alternate embodiments, one or more of the steps listed in FIG. 14 may be eliminated. Additionally, the steps listed in FIG. 14 are not limited to the particular order in which they are described.

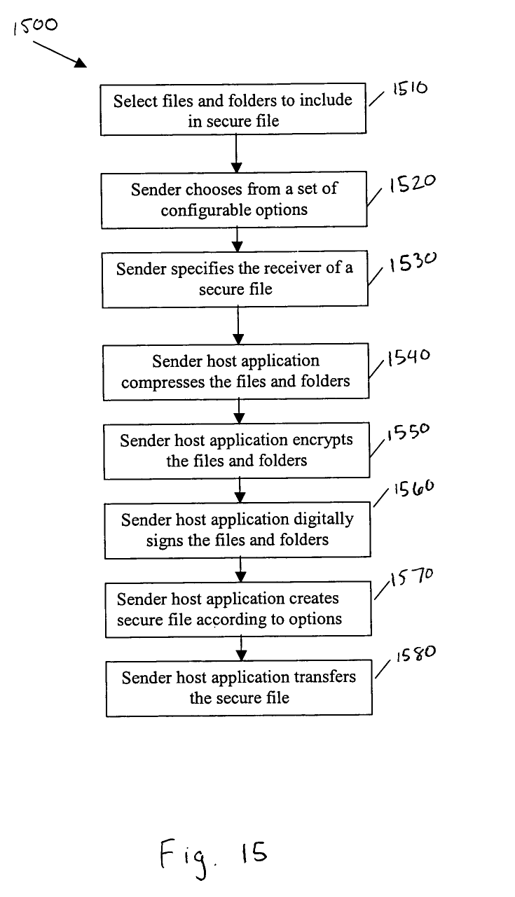

FIG. 15 illustrates a method of creating a secure file 1500 according to an embodiment of the present invention. First, at step 1510, the sender selects files and folders to include into the secure file. The sender may use a computer process to automate the selection of files and folders included in the secure file. A sender host application can read a list of file names and folders to include in the secure file. Alternatively, files and folders may be selected using dialogs and menus provided by the sender host application. In another embodiment, files and folders may be selected using a file manager application to drag and drop selected files onto a window of the sender host application. File and folder names may be identified individually, or as a group.

Next, at step 1520, the sender chooses from a set of configurable options controlling how the sender host application creates the secure file. One such selectable option relates to data compression. Data compression is a method for using a computer algorithm for reducing the size of a file by reducing the number of bytes in the file. After compression the file will contain fewer bytes than were in the file before being compressed. The number of bytes in a file may be reduced by removing repeating patterns of bytes, thus reducing redundancy of the data. One example of a data compression algorithm is Deflate. Deflate is a data compression algorithm invented by PKWARE. Other compression algorithms including LZMA and LZO may also be used. The sender may choose to compress the files and folders placed in the secure folder. The sender may also choose which data compression algorithm is used to compress the files and folders. Alternatively, the files and folders placed into the secure file may not be compressed. The files and folders may also be compressed using more than one compression algorithm. In another embodiment, the secure file itself may be compressed.

Another example of a selectable option relates to data encryption. The sender may choose to encrypt the files and folders placed in the secure folder. The sender may also choose which data encryption algorithm is used to encrypt the files and folders. There are a number of encryption algorithms compatible with embodiments of the invention, including asymmetric and symmetric key algorithms. Some examples of encryption algorithms that may be used by various embodiments include: Diffie-Hellman, DSS, ElGamal, RSA, SSL, PGP, GPG, Twofish, Serpent, AES, Blowfish, CAST5, RC4, RDES, SSH, SILC, IKE and IDEA. Alternatively, the files and folders placed into the secure file may not be encrypted. The files and folders may also be encrypted using more than one encryption algorithm. In another embodiment, the secure file itself may be encrypted. Other configurable options may be selected for creating a secure file.

Next, at step 1530, the sender specifies the receiver of the secure file. The sender specifies the receiver using command parameters provided by the sender host application. The receiver may be specified using characteristics of the receiver. Characteristics of a receiver include name, physical address, e-mail address, ip address, organization name, account number, phone number, or any other identifying characteristic.

At step 1540, the sender host application compresses the files and folders selected for the secure file. The compression takes place as configured above. If data compression has not been selected, this step is be skipped.

The sender host application encrypts the files and folders selected for the secure file at step 1550. The sender host application uses keys for encryption. A key may be a single key used by the sender and each receiver. Alternatively, a key may be unique to the sender and to each receiver. An example of a key is a password. Another example of a key is a public key as may be part of an X.509 digital certificate. Each sender or receiver having a key used to encrypt computer files may use the key to decrypt the computer files after the secure file is received.

More than one public key may be specified for use by the sender host application to encrypt files and folders placed into the secure file. A public key that is a contingency key may also be specified. A contingency key is a public key that may be used to encrypt computer files so that those computer files may be decrypted using a private key of a contingency key holder. A private key is a key that resides only in the possession of an individual or an organization and that uniquely identifies an individual or an organization through a digital certificate that is used to bind the identity of an individual or an organization to a private key. A contingency key holder is a person or a process that must be able to decrypt computer files under special circumstances. An example of a special circumstance may be the loss or destruction of another key that was used to encrypt computer files. In this circumstance the contingency key holder uses his/her private key to decrypt the computer files when they may no longer be decrypted with another key. A contingency key holder may be a sender or a receiver. The use of a contingency key to encrypt computer files in a secure file ensures the sender, or the sender's organization that the information contained in the secure file is not lost. Alternatively, if data encryption has not been selected, this step may be skipped.

Next, at step 1560, the sender host application digitally signs the files and folders placed into the secure file. The sender host application uses a private key specified by the sender to digitally sign the secure file. More than one private key may be used to sign the secure file. At least one of the private keys used to digitally sign the secure file corresponds to the public key contained within the trusted sender credential that identifies the sender as a trusted source.

At step 1570, the sender host application creates the secure file using the options specified in the above steps. After the secure file is created, at step 1580, the sender host application transfers the secure file to one or more receivers. In alternate embodiments, one or more of the steps listed in FIG. 15 may be eliminated. Additionally, the steps listed in FIG. 15 are not limited to the particular order in which they are described.

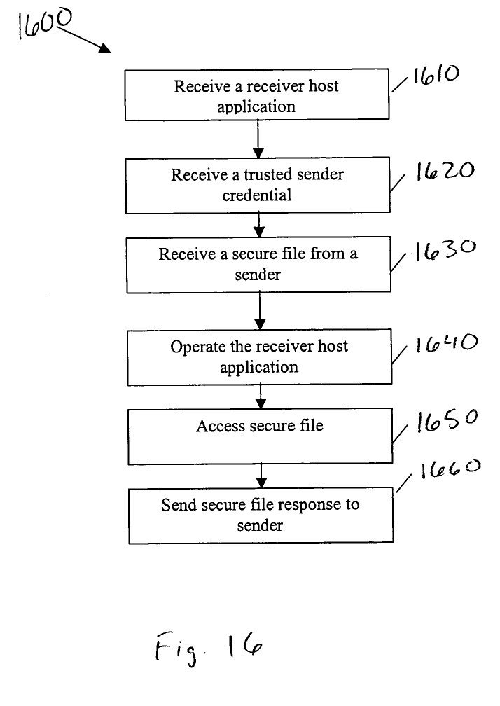

FIG. 16 illustrates a method of receiving a secure file 1600 according to an embodiment of the present invention. First in step 1610, a receiver receives a receiver host application. The receiver host application operates similar to the receiver host applications described above. Specifically, the receiver can operate the receiver host application to access a secure file from a sender. A sender or a trusted credential creator may provide the receiver host application.

Next, at step 1620, the receiver receives a trusted sender credential. The trusted sender credential operates similarly to the trusted sender credentials above. As described above, the trusted sender credential contains digital certificate information identifying a sender. The receiver host application utilizes the trusted sender credential to verify that a secure file originated from a sender. Additionally, as described above, a trusted sender credential may contain data or instructions that limit the functionality of a receiver host application. The data or instructions may also be known as receiver control data. The sender may provide the data or instructions limiting the functionality of the receiver host application to the trusted credential creator or trusted third party. A sender or a trusted credential creator may provide the trusted sender credential.

Then, at step 1630, the receiver receives a secure file from a sender. The sender may transmit the secure file to the receiver as described above. The secure file may be encrypted and digitally signed.

At step 1640, the receiver operates the receiver host application. Once the receiver receives the secure file and the trusted sender credential, the receiver activates a receiver host application that then retrieves digital certificate information from the trusted sender credential and digital certificate information from the secure file. The receiver host application authenticates the digital signature of the trusted credential creator contained in the trusted sender credential using a digital certificate of trusted credential creator contained within the receiver host application. If the receiver host application authenticates the digital signature of the trusted credential creator or trusted third party, then the receiver host application compares a first digital certificate in the trusted sender credential to the digital certificate that was used to digitally sign the secure file. The secure file may be digitally signed with more than one digital certificate. If the secure file has been digitally signed and a first digital certificate of the secure file does not match the digital certificate in the trusted sender credential, then the receiver host application may compare each digital certificate in the secure file to the digital certificate in the trusted sender credential until a match is found. Additionally, trusted sender credential may contain more than one digital certificate. If the secure file has been digitally signed and a digital certificate of the secure file does not match a first digital certificate in the trusted sender credential, then receiver host application may compare the digital certificate in the secure file to each digital certificate in the trusted sender credential until a match is found. If the digital certificates match, then the receiver host application provides access to the secure file.

Additionally, the receiver host application may prevent access to the secure file under other conditions. For example, if the receiver host application cannot locate a trusted sender credential for sender, then the receiver host application may prevent the receiver from accessing the secure file. If the digital signature of the trusted sender credential is not authenticated to the identity of the trusted credential creator that issued the trusted sender credential, the receiver host application may end operation and the receiver cannot access the secure file. In another example, if the secure file was not signed, the receiver host application will not allow the receiver to access the secure file. In another alternate embodiment, the receiver accepts the sender as a trusted source before receiving the secure file. The digital certificates may also be in the form of X.509 certificates, PGP certificates, or any other suitable certificate utilizing public and private keying.

The receiver utilizes the receiver host application at step 1650 to access the secure file. As described above, the receiver host application provides the receiver with access to the contents of the secure file. However, the receiver host application may limit the actions a receiver may perform on a secure file. Specifically, the receiver host application may not provide the same functionality as a sender host application. The sender may restrict the ability of the receiver to use certain functions of the receiver host application. For example, the sender may restrict the receiver host application to only allow the receiver to open and read the secure file from the sender. The sender may also restrict the ability of the receiver to use the receiver host application to create additional secure files. Additionally, the sender may allow the receiver to utilize the receiver host application to create a secure file, but may only allow the secure file to be sent to the sender. The receiver host application may be limited to only create secure files encrypted with the public encryption key of the sender. The sender restricts the functionality of the receiver host application through the trusted sender credential. When requesting a trusted sender credential, the sender may provide a data file that contains limiting instruction to a trusted third party. The trusted credential creator includes these limiting instructions when creating the trusted sender credential. When the receiver host application operates, the receiver host application checks the trusted sender credential for the presence of limiting instructions from the sender. If the receiver host application detects limiting instructions, the receiver host application follows the limiting instructions.

Finally, at step 1660, the receiver may utilize the receiver host application to respond to the sender with a secure file. As described above, the receiver host application may provide limiting functionality to the receiver. In some embodiments, the receiver host application may allow a receiver to create a secure file. In other embodiments, this newly created secure file may be intended for the sender. The receiver will provide data to the receiver host application. Then the receiver host application will create a secure file that may only be accessed by the sender. The receiver host application may prevent unauthorized access through the use of digital certificates or encryption. Then the receiver may send the newly created secure file to the sender, optionally using the receiver host application for the transmission of the secure file.

In alternate embodiments, one or more of the steps listed in FIG. 16 may be eliminated. Additionally, the steps listed in FIG. 16 are not limited to the particular order in which they are described.

In an alternative embodiment, a trusted credential creator may create a trusted receiver credential. A trusted receiver credential is a digital document that uniquely identifies the receiver as a trusted receiver of a sender that is a trusted source. The identity of the receiver is bound to the digital document using a digital certificate. Further, the digital certificate of the receiver is authenticated as a trusted receiver using a digital signature of a trusted sender or using a digital signature of a trusted credential creator or trusted third party. An example of a trusted credential creator is PKWARE. One such format of a trusted receiver credential is that of a file in the ZIP format. The public key of a receiver is placed into the trusted receiver file by the trusted credential creator or by a trusted sender and is digitally signed using the private key of the trusted credential creator or of the trusted sender. More than one public key of a receiver may be placed into a trusted receiver file.

First, the receiver that has received a secure file from the trusted sender contacts the trusted credential creator to request the trusted receiver credential. The receiver may use this trusted receiver credential to digitally sign secure files. The trusted receiver credential may combine more than one receiver together as a trusted receiver entity. A receiver may initiate the request of a trusted sender credential electronically, or through physical media.

The trusted credential creator requests keys from the receiver. The trusted credential creator may request public keys such as an X.509 certificate or any other digital certificate used for digitally signing data.

Next, the receiver delivers keys to the trusted credential creator or trusted third party. Specifically, the receiver may deliver one or more signing keys to the trusted third party. These signing keys may be X.509 certificates or any other key used to digitally sign data. The receiver may also deliver one or more encryption keys to the trusted third party. These encryption keys may be any key format suitable for encrypting or decrypting data. The signing keys and encryption keys may be the same key. In one embodiment, the signing key and the encryption key may be delivered to the trusted credential creator using a secure internet file transfer protocol to protect the keys from exposure to an unauthorized receiver and to ensure the confidentiality of the request for the trusted credential by the receiver.

After receiving the keys from receiver, the trusted credential creator will verify that each received key is from receiver. The trusted credential creator sends unique information relating to each received key to receiver. The receiver verifies that the unique information relates to the receiver's keys. The trusted credential creator also confirms that the receiver intended to establish the trusted sender credential. Examples of unique information about a key include a serial number, key length, and date of creation. Other unique information may also be used. Verification of a key establishes trust in the holder of the key. Key verification may be performed electronically, by telecommunications, or through physical media.

Next, the trusted credential creator uses a partner internal packaging interface to package the receiver's keys into the trusted receiver credential. The partner internal packaging interface comprises a partner distribution package (PDP) packaging tool used to create a trusted receiver credential. The trusted receiver credential may alternatively be known as a partner distribution package.

The partner distribution package (PDP) packaging tool is a software program. The partner distribution package packaging tool is operated by the partner internal packaging interface as follows. First, an input file is created in the format of an XML data file. Other file formats may be used. The content of the input file is as follows:

<partner name=“Name of partner” id=“id number”>

<comment>Comment from partner</comment>
<signer file=“certificate file containing Authorized Signer”/>
<signer_ca file=“certificate file containing CA certificates

for Authorized Signer”/>

<signer_root file=“certificate file containing root

certificates for Authorized Signer”/>

<recipient file=“certificate file containing Authorized

Recipients”/>

<recipient_ca file=“certificate file containing CA

certificates for Authorized Recipients”/>

<recipient_root file=“certificate file containing root

certificates for Authorized Recipients”/>

<crl file=“file containing CRL information for either signers

or recipients”/>

<sponsor file=“certificate file containing sender

certificate(s)”/>

<sponsor_options encrypt_algorithm=“aes”/>
<sponsor_options compress_alrogithm=“deflate”/>
<output file=“name of file to be created by this program”/>

</partner>

Next, the trusted credential creator runs the PDP packaging tool using the partner internal packaging interface. The input file is provided to the PDP packaging tool as a command parameter. The PDP packaging tool opens and reads the contents of the input file and writes the trusted receiver credential.

The PDP packaging tool places at least one trusted public key of receiver into the trusted receiver credential file and signs the trusted receiver credential file using a private key that uniquely identifies the trusted third party. A trusted key may also be described as a verified key. Additional trusted public keys of receiver may also be placed into the same trusted sender credential file that contains the first trusted public key of the receiver. Each additional trusted public key is also digitally signed using a private key that uniquely identifies trusted third party.

Additionally, the PDP packaging tool places a data file into the trusted receiver credential file. The data file contains information about receiver and about the public keys of receiver that are contained in the trusted receiver credential. One example of information included in the data file is the hash of each public key contained in the trusted receiver credential. The hash of each public key is recorded to ensure that trusted keys are contained in the trusted receiver credential file. The data file may also include a comment to record information for the sender or a new receiver. The data file may also include a date value to record when trusted credential creator created the trusted receiver credential file for the receiver. The PDP packaging tool may also place a unique identifier for the receiver into the data file. The trusted credential creator assigns the unique identifier for the receiver.

The PDP packaging tool may also write a type value into the data file of the trusted receiver credential. The type value may be included to restrict the functionality of a host application. In an alternative embodiment, the type value may be placed anywhere within the trusted receiver credential. In another embodiment, this type value may be stored in a receiver host application sent to second receiver.

The PDP packaging tool may also include other information in the data file stored in the trusted receiver credential. One format for the data file may be XML. Other formats may also be used. The data file will be digitally signed using the private key of trusted credential creator when it is placed into the trusted receiver credential file. One example of the XML data file is as follows:

<partner version=“1” id=“99” name=“PKWARE PartnerLink Network”
type=“0” files=“0x1” flags=“0x0” creation_date=“2006-09-06
20:49:22”>

<auth_list>

<pk_hash>
982ABCDXYZ92929292B2620BDF66EA132DEC3B787
</pk_hash>
<pk_hash>
123456789ABCDEF123456789ABCEDF123456789ABC
</pk_hash>

</auth_list>
<sponsor>

<pk_hash>
1234960abdf982ABCDXYZ929BDF66EA132DE8765487
</pk_hash>
<pk_options encrypt_algorithm=“aes”/>
<pk_options compress_alrogithm=“deflate”/>

</sponsor>
<comment>
PKWARE PartnerLink Partner Distribution Package
</comment>

</partner>

Next, the PDP packaging tool writes the trusted receiver credential. The PDP packaging tool writes the trusted receiver credential as a ZIP file. The trusted receiver credential has name that uniquely identifies the receiver. Specifically, the format of the file name of the trusted receiver credential will be composed of a numeric value matching to the unique identifier for receiver that was assigned by trusted credential creator or trusted third party. Additionally, the trusted receiver credential file has a file name extension of .DAT. In alternative embodiments, other file types, names, and extensions may be sued. The .DAT file that results from the above steps is the trusted receiver credential file for a receiver.

The trusted credential creator will encrypt the trusted receiver credential before delivery to the receiver. The encryption key used to encrypt the trusted receiver credential will match a unique encryption key provided to the trusted credential creator by the receiver. One example of an encryption key that may be used to encrypt the trusted receiver credential is the public encryption key placed into the trusted receiver credential. There are a number of encryption algorithms compatible with embodiments of the invention, including asymmetric and symmetric key algorithms. Some examples of encryption algorithms that may be used by various embodiments include: Diffie-Hellman, DSS, ElGamal, RSA, SSL, PGP, GPG, Twofish, Serpent, AES, Blowfish, CAST5, RC4, RDES, SSH, SILC, IKE and IDEA. In an alternative embodiment, the trusted receiver credential may be delivered unencrypted.

The trusted credential creator will also deliver to the receiver a program to decrypt the encrypted form of the trusted receiver credential. The receiver will use the decryption program to decrypt the trusted receiver credential file. After the receiver decrypts the trusted receiver credential file, the receiver will be established as a trusted receiver.

After providing the trusted receiver credential to the receiver host application, the receiver may create secure files that may be decrypted by the sender. The trusted receiver credential may restrict the operation of a receiver host application. The secure files created using a trusted receiver credential will automatically be encrypted for the sender and for the receiver. Further, the secure files created using the trusted receiver credential will automatically be digitally signed using the private key of the trusted receiver. Further, operation of the receiver host application may be restricted to operate only using options set by the sender. One example of an option that may be restricted is data compression. The sender may restrict operation of the receiver host application to use only a specified data compression algorithm. Other options may be restricted.

In alternative embodiments, senders, receivers, and trusted credential creators or trusted third parties may function in more than one capacity. For example, a sender may also operate as a trusted credential creator and/or receiver. Likewise a trusted credential creator may operate as a receiver and/or a sender. A receiver may operate as a sender and/or a trusted credential creator or trusted third party. Additionally, alternative embodiments allow for a plurality of senders, receivers, and trusted third parties. For example, a sender may send a secure file to a plurality of receivers. In another example, a plurality of trusted third parties may provide trusted credentials.

The present embodiments improve upon the prior art. Specifically, a secure file format is taught that enables the secure exchange of information between a sender and a receiver. The systems and methods utilize a mutually trusted credential creator to authenticate the identities of the sender and the receiver. The secure file format may not be altered without the consent of the sender. When a sender creates a secure file, the secure, encrypted file format prevents unauthorized access until the intended receiver decrypts the secure file. Thus the secure file format continues to protect the secure file after transmission through a network. The present embodiments operate with a variety of computing platforms, encryption methods, compression algorithms, and software programs. Finally, the secure file format allows multiple senders to sign a single secure file with their individual digital certificates.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for generating a trusted sender credential including:
receiving a key from a sender at a trusted credential creator, wherein said trusted credential creator confirms the identity of said sender; and
generating a trusted sender credential based on said key after confirming the identity of said sender.

2. The method of claim 1 wherein said trusted credential creator confirms the identity of said sender using a process that takes place after said key is received by said trusted credential creator.

3. The method of claim 1 wherein said trusted credential creator confirms the identity of said sender by calling said sender on a telephone.

4. The method of claim 1 wherein said trusted credential creator confirms the identity of said sender by e-mailing said sender.

5. The method of claim 1 wherein said trusted credential creator confirms the identity of said sender by meeting said sender in person.

6. The method of claim 1 wherein said trusted sender credential receives a plurality of keys from said sender.

7. The method of claim 6 wherein said plurality of keys are used in generating said trusted sender credential.

8. The method of claim 6 wherein said plurality of keys are included in said trusted sender credential.

9. The method of claim 1 wherein said key is one of an encryption key and a signing key.

10. The method of claim 6 wherein said plurality of keys includes at least one of an encryption key and a signing key.

11. The method of claim 6 wherein said plurality of keys includes at least one encryption key and at least one signing key.

12. The method of claim 1 wherein said trusted credential creator receives receiver control data from said sender in addition to said key.

13. The method of claim 12 wherein said receiver control data is included in said trusted sender credential.

14. The method of claim 13 wherein said receiver control data is adapted to impact the operation of an application at a receiver of said trusted sender credential.

15. The method of claim 13 wherein said receiver control data is adapted to impact the operation of an application at a plurality of receivers of said trusted sender credential.

16. The method of claim 14 wherein said receiver control data includes first receiver control data and second receiver control data.

17. The method of claim 16 wherein said first receiver control data is adapted to impact the operation of an application at said first receiver and said second receiver control data is adapted to impact the operation of an application at said second receiver.

18. The method of claim 17 wherein said first receiver control data provides a first impact on the operation of an application at said first receiver and said second receiver control data provides a second impact on the operation of an application at said second receiver.

19. The method of claim 6 wherein said plurality of keys includes keys from a plurality of senders.

20. The method of claim 1 wherein said trusted credential creator is located at said sender.

21. The method of claim 1 wherein said trusted credential creator is located outside said sender.

22. A method of securely transmitting data including:
receiving a trusted sender credential from a trusted credential creator at a sender;
combining, at said sender, said trusted sender credential with a secure data file to be transmitted; and
transmitting said trusted sender credential and said secure data file.

23. The method of claim 22 wherein said trusted sender credential and said secure data file are aggregated into a single communication.

24. The method of claim 22 wherein said trusted sender credential and said secure data file are transmitted as two separate communications.

25. The method of claim 22 wherein said trusted sender credential and said secure data file are transmitted to a receiver.

26. The method of claim 22 wherein said trusted sender credential and said secure data file are transmitted to a plurality of receivers.

27. The method of claim 22 wherein said trusted sender credential includes a plurality of keys.

28. The method of claim 27 wherein said plurality of keys include at least one encryption key.

29. The method of claim 27 wherein said plurality of keys include at least one signing key.

30. The method of claim 27 wherein said plurality of keys include a first key adapted to provide access for a first receiver and a second key adapted to provide access for a second receiver.

31. The method of claim 22 wherein said trusted sender credential includes receiver control data.

32. The method of claim 31 wherein said receiver control data is adapted to impact the operation of an application at a receiver.

33. The method of claim 31 wherein said receiver control data is adapted to impact the operation of an application at a plurality of receivers of said trusted sender credential.

34. The method of claim 33 wherein said receiver control data includes first receiver control data associated with a first receiver and second receiver control data associated with a second receiver.

35. The method of claim 34 wherein said first receiver control data is adapted to impact the operation of an application at said first receiver and said second receiver control data is adapted to impact the operation of an application at said second receiver.

36. The method of claim 35 wherein said first receiver control data provides a first impact on the operation of an application at said first receiver and said second receiver control data provides a second impact on the operation of an application at said second receiver.

37. The method of claim 22 wherein said sender receives a first trusted sender credential and a second trusted sender credential.

38. The method of claim 73 wherein said first trusted sender credential is combined with said secure data file and transmitted to a first receiver and said second trusted sender credential is combined with said secure data file and transmitted to a second receiver.

39. The method of claim 38 wherein said first trusted sender credential produces an impact on said first receiver that is different from an impact produced on said second receiver by said second trusted sender credential.

40. A method for controlling access to a secure data file including:
receiving a secure data file and a trusted sender credential at a receiver, wherein said secure data file has been encrypted using a sender key, wherein said trusted sender credential includes a verified sender key; and
providing access to said secure data file when said verified sender key matches said sender key.

41. The method of claim 40 wherein said trusted sender credential is received from a sender.

42. The method of claim 40 wherein said trusted sender credential is received from a trusted credential creator.

43. The method of claim 40 wherein said trusted sender credential includes control data.

44. The method of claim 43 wherein said control data is adapted to impact the operation of an application at said receiver.

45. The method of claim 44 wherein said control data includes first control data and second control data.

46. The method of claim 45 wherein said secure data file and said trusted sender credential are received at a plurality of receivers.

47. The method of claim 45 wherein said first control data is adapted to impact the operation of an application at a first receiver and said second control data is adapted to impact the operation of an application at a second receiver.

48. The method of claim 40 wherein said secure data file and said trusted sender credential are received at a plurality of receivers.

49. The method of claim 44 wherein said control data limits secure communication from said receiver to said sender.

50. A system for generating a trusted sender credential including:
trusted credential creator,
wherein said trusted credential creator receives a key from a sender,
wherein said trusted credential creator confirms the identity of said sender,
wherein said trusted credential creator generates a trusted sender credential based on said key after confirming the identity of said sender.

51. A system for securely transmitting data including:
a sender receiving a trusted sender credential from a trusted credential creator,
wherein said sender combines said trusted sender credential with a secure data file and transmits said trusted sender credential and said secure data file.

52. A system for securely transmitting data including:
a sender transmitting a key to a trusted credential creator; and
a trusted credential creator receiving said key from said sender, confirming the identity of said sender, generating a trusted sender credential based on said key after confirming the identity of said sender, and transmitting said trusted sender credential to said sender,
wherein said sender combines said trusted sender credential with a secure data file and transmits said trusted sender credential and said secure data file.

53. A system for controlling access to a secure data file including:
a receiver receiving a secure data file and a trusted sender credential,
wherein said secure data file has been encrypted using a sender key,
wherein said trusted sender credential includes a verified sender key,
wherein said receiver provides access to said secure data file when said verified sender key matches said sender key.

54. A system for controlling access to a secure data file including:
a sender transmitting a secure data file and a trusted sender credential to a receiver, wherein said secure data file has been encrypted using a sender key, wherein said trusted sender credential includes a verified sender key; and
a receiver providing access to said secure data file when said verified sender key matches said sender key.

55. A system for securely transmitting data including:
a sender transmitting a key to a trusted credential creator;
a trusted credential creator receiving said key from said sender, confirming the identity of said sender, generating a verified sender key based on said key after confirming the identity of said sender, including said verified sender key in said trusted sender credential, and transmitting said trusted sender credential to said sender,
wherein said sender combines said trusted sender credential with a secure data file including a sender key and transmits said trusted sender credential and said secure data file; and
a receiver receiving said trusted sender credential and said secure data file and providing access to said secure data file when said verified sender key matches said sender key.
